(19) United States
(12) Patent Application Publication
(10) Pub. No.: US 2022/0332493 A1
(43) Pub. Date: Oct. 20, 2022

(54) VACUUM-BASED RETRIEVING AND DISPENSING

(71) Applicant: HERO HEALTH INC., New York, NY (US)

(72) Inventors: Craig SUNADA, Leonardo, NJ (US); Greggory Paul HAGOPIAN, Briarwood, NY (US); Kyung Ryung PARK, Hayward, CA (US); Marko MARKOV, Zrenjanin (RS); Jeff WHALLEY, Falls Church, VA (US)

(21) Appl. No.: 17/723,356

(22) Filed: Apr. 18, 2022

Related U.S. Application Data
(60) Provisional application No. 63/176,133, filed on Apr. 16, 2021.
(60) Provisional application No. 63/308,805, filed on Feb. 10, 2022.

(51) Int. Cl. B65D 83/04; A61J 7/00; A61J 1/03

(52) U.S. Cl. CPC B65D 83/0409; A61J 7/0076; A61J 1/03; B65D 2583/0472; B65D 2583/0404; A61J 2200/70

(57) ABSTRACT

The methods of the present disclosure are generally directed to controlling noise and performance associated with a vacuum system for retrieving and dispensing dispensable units, such as pills. By way of example and not limitation, such methods may be useful for addressing the particular challenges associated with automated dispensing of pills (or other dispensable units) in environments—such as many household or point-of-care environments—that are sensitive to noise and/or in environments in which the retrieval device is generally operated by users without specialized training in maintaining the retrieval device.

### CROSS-REFERENCE TO RELATED APPLICATIONS

This application claims priority to U.S. Provisional Application Ser. No. 63/176,133, filed Apr. 16, 2021, and to U.S. Provisional Application Ser. No. 63/308,805, filed Feb. 10, 2022, with the entirety of each of these applications hereby incorporated herein by reference.

### BACKGROUND

In automated systems, suction produced by a vacuum system can be useful for retrieving and dispensing dispensable units of arbitrary size, orientation, texture, and weight. Further, the use of suction may reduce the likelihood of damage to certain types of dispensable units, such as pills, that generally need to be dispensed intact for accurate dosing. However, vacuum systems used to generate suction can be noisy and, in certain cases, can exhibit variations in performance over time. Such noise and variation in performance over time may present particular challenges, for example, in household environments

### SUMMARY

The methods of the present disclosure are generally directed to controlling noise and performance associated with a vacuum system for retrieving and dispensing dispensable units, such as pills. By way of example and not limitation, such methods may be useful for addressing the particular challenges associated with automated dispensing of pills (or other dispensable units) in environments—such as many household or point-of-care environments—that are sensitive to noise and/or in environments in which the retrieval device is generally operated by users without specialized training in maintaining the retrieval device.

According to one aspect, a method of controlling a vacuum system of a retrieval device for pills includes actuating a vacuum pump in fluid communication with a nib defining an opening, receiving a first pressure measurement signal (Sₚ₁) indicative of an open pressure (Pₒₚₑₙ) of the nib with the vacuum pump actuated and the opening unobstructed by material external to the nib, based on the first pressure measurement signal (Sₚ₁), adjusting a first threshold pressure (P_{pick}) indicative of a pressure below which the opening of the nib is in at least partial sealed engagement with a pill, and controlling operation of the vacuum pump based on the first threshold pressure (P_{pick}).

In some implementations, adjusting the first threshold pressure (P_{pick}) may be based on a predetermined relationship between first threshold pressure (P_{pick}) and the open pressure (Pₒₚₑₙ). For example, the predetermined relationship may include an empirical relationship between the first threshold pressure (P_{pick}) and the open pressure (Pₒₚₑₙ). As another example, the predetermined relationship between the first threshold pressure (P_{pick}) and the open pressure (Pₒₚₑₙ) may be a function of altitude of the retrieval device.

In certain implementations, adjustment of the first threshold pressure (P_{pick}) may include initiating a remedial action for a vacuum pump in fluid communication with the nib.

In some implementations, controlling operation of the vacuum pump may include controlling a supply voltage of the vacuum pump.

In certain implementations, the method may further include comparing the open pressure (Pₒₚₑₙ) to a predetermined cut-off pressure and initiating a remedial action if the open pressure (Pₒₚₑₙ) is below the predetermined cut-off pressure. For example, the remedial action may include aborting an attempt to retrieve the pill, sending an error condition to a server in communication with the retrieval device, or a combination thereof.

In some implementation, the method may further include receiving a second pressure measurement signal (Sₚ₂) indicative of pressure in the nib with the opening in contact with the pill, actuating a positioner to move the nib from a first position above a container to a second position above a chute, as the nib moves from the first position to the second position, comparing the second pressure measurement signal (Sₚ₂) to a second threshold pressure (Pₛₑₐₗ) indicative of pressure below which the opening of the nib is in sealed engagement with a pill, and based on comparison of the second pressure measurement signal (Sₚ₂) to the second threshold pressure (Pₛₑₐₗ), determining dispensation of the pill in the chute. In some instances, comparing the second pressure measurement to the second threshold pressure (Pₛₑₐₗ) may include adjusting the second threshold pressure (Pₛₑₐₗ) based on one or more parameters of an environment about the retrieval device. comparing the second pressure. The one or more parameters of the environment about the retrieval device may be determined based on a location of the retrieval device. For example, adjusting the second threshold pressure (Pₛₑₐₗ) may include receiving the location as an input from a user. Further, or instead, adjusting the second threshold pressure (Pₛₑₐₗ) may include receiving the location from a remote server in communication with the retrieval device. For example, the location of the retrieval device may be based on an Internet Protocol (IP) address of the retrieval device in communication with the remote server. The one or more parameters of the environment about the retrieval device may include altitude at a location of the retrieval device. Adjusting the second threshold pressure (Pₛₑₐₗ) may include decreasing the second threshold pressure (Pₛₑₐₗ) with increasing altitude.

Further, or instead, the method may further include releasing vacuum pressure at the opening of the nib if the second pressure measurement signal (Sₚ₂) remains below the second threshold pressure (Pₛₑₐₗ) from the first position above the container to the second position above the chute, wherein releasing the vacuum pressure at the opening of the nib includes deactivating the vacuum pump and opening a valve in fluid communication with vacuum pump and the opening of the nib. Still further, or instead, the method may include, following release of the vacuum pressure at the opening of the nib, closing the valve, re-actuating the vacuum pump, receiving a third pressure signal (Sₚ₃) indicative of pressure at the opening of the nib with the valve closed and the vacuum pump re-actuated, comparing the third pressure signal (Sₚ₃) to a third threshold pressure (Pₕₑₐₗₜₕ) indicative of blockages in the vacuum system, and determining health of the vacuum system based on the comparison of the third pressure signal (Sₚ₃) to the third threshold pressure (Pₕₑₐₗₜₕ). Further, or instead, the method may include, if the third pressure signal (Sₚ₃) corresponds to a pressure greater than the second threshold pressure (Pₛₑₐₗ) and less than the third threshold pressure (Pₕₑₐₗₜₕ), sending an error signal to a user interface of the retrieval device to indicate an anomalous condition in the vacuum system. The third threshold pressure (Pₕₑₐₗₜₕ) may be a predetermined multiple of the open pressure (Pₒₚₑₙ). For example, a predetermined ratio of the open pressure (Pₒₚₑₙ) to the third threshold pressure (Pₕₑₐₗₜₕ) is less than 1. As a more specific example, the predetermined ratio of the open pressure (Pₒₚₑₙ) to the third threshold pressure (Pₕₑₐₗₜₕ) may be greater than about 0.15 and less than about 0.4.

Further or instead, the method may include initiating a remedial action if the second pressure measurement signal (Sₚ₂) increases above the second threshold pressure (Pₛₑₐₗ) before the nib reaches the second position above the chute, as the nib moves toward the second position from the first position above the container. Initiating the remedial action may include generating an error indicating that the pill has been dropped.

According to another aspect, a method of removing debris from a vacuum system of a retrieval device for pills may include detecting blockage of a nib defining an opening, actuating a positioner to move the nib to a predetermined height above a chute, the predetermined height aligning a flexible portion of the nib with a surface disposed between the chute and a support releasably securable to a container and, with the nib at the predetermined height, actuating the positioner to move the nib back-and-forth between an undeflected state above the chute and a deflected state in contact with the surface with the opening of the nib directed toward the chute throughout back-and-forth movement of the nib.

In certain implementations, detecting blockage of the nib may include actuating a vacuum pump in fluid communication with the opening of the nib, receiving a pressure measurement signal (Sₚ) indicative of a first open pressure (Pₒₚₑₙ) at the opening of the nib with the vacuum pump actuated and the opening of the nib positioned away from material external to the nib, and determining an extent of blockage in the nib based on the pressure measurement signal (Sₚ).

In some implementations, moving the nib back-and-forth may include moving the nib through a predetermined number of back-and-forth movements. For example, if the predetermined number of back-and-forth movements is reached, an error code may be generated to indicate that the retrieval device has a persistent blockage.

In certain implementations, the method may further include determining whether blockage of the nib is cleared, wherein moving the nib back-and-forth includes moving the nib back-and-forth until the blockage of the nib is cleared. For example, determining whether blockage of the nib is cleared may be based on one or more signals indicative of pressure between the nib and an actuated vacuum pump.

According to yet another aspect, a method of controlling noise of a vacuum system in a retrieval device for pills may include sending a vacuum control signal to actuate a vacuum pump at a predetermined duty cycle, receiving a pressure measurement signal (Sₚ) indicative of pressure in a nib with the vacuum pump actuated and in fluid communication with an opening defined by the nib, comparing pressure in the nib to a predetermined threshold pressure and, based on comparison of pressure in the nib to the predetermined threshold pressure, adjusting a duty cycle of the vacuum pump relative to the predetermined duty cycle while the opening of the nib is in sealed engagement with a pill.

In some implementations, sending the vacuum control signal to actuate the vacuum pump at the predetermined duty cycle may include increasing the duty cycle of the vacuum pump as the nib is moved, along a z-axis, into a container for a retrieval attempt. Increasing the duty cycle of the vacuum pump as the nib is moved into the container may include ramping up the duty cycle of the vacuum pump as the nib is lowered into the container.

In certain implementations, the predetermined threshold pressure may be based on a first pressure (Pₛₑₐₗ) below which the opening of the nib is in sealed engagement with the pill. The predetermined threshold pressure may be equal to the first pressure (Pₛₑₐₗ). Further, or instead, the predetermined threshold pressure may be a predetermined fraction of the first pressure (Pₛₑₐₗ).

In some implementations, the predetermined threshold pressure may be based on a second pressure (P_{pick}) indicative of a pressure below which the opening of the nib is in at least partial sealed engagement with the pill.

In certain implementations, adjusting the duty cycle of the vacuum pump relative to the predetermined duty cycle may include decreasing the duty cycle of the vacuum pump from the predetermined duty cycle to a reduced duty cycle if pressure in the nib is less than the predetermined threshold pressure. For example, the reduced duty cycle of the vacuum pump may be greater than about 30 percent and less than about 40 percent. Further, or instead, one or more of the predetermined duty cycle or the reduced duty cycle may be based on historical performance data of the vacuum pump in previous retrieval attempts. Additionally, or alternatively, one or more of the predetermined duty cycle or the reduced duty cycle may be based on altitude of the retrieval device, type of the pill, or a combination thereof. In some instances, with the vacuum pump operating at the reduced duty cycle, adjusting the duty cycle of the vacuum pump relative to the predetermined duty cycle may include increasing the duty cycle from the reduced duty cycle to the predetermined duty cycle of the vacuum pump if pressure in the nib is greater than or equal to the predetermined threshold pressure. Decreasing the duty cycle of the vacuum pump may include, for example, turning the vacuum pump off. Further or instead, increasing the duty cycle from the reduced duty cycle to the predetermined duty cycle may include turning the vacuum pump on after the vacuum pump has been shut off. In some instances, turning the vacuum pump on after the vacuum pump has been shut off may include increasing the duty cycle of the vacuum pump to the predetermined duty cycle. In certain instances, turning the vacuum pump on after the vacuum pump has been shut off may include increasing the duty cycle of the vacuum pump to an intermediate duty cycle lower than the predetermined duty cycle.

In some implementations, adjusting the duty cycle of the vacuum pump relative to the predetermined duty cycle may include incrementally changing the duty cycle of the vacuum pump over a predetermined period. For example, incrementally changing the duty cycle of the vacuum pump over the predetermined period may include changing the duty cycle of the vacuum pump according to a ramp function over the predetermined period. The predetermined period may be between 2 seconds and 20 seconds.

In certain implementations, adjusting the duty cycle of the vacuum pump may be limited between a predetermined upper bound and a predetermined lower bound. For example, the predetermined duty cycle of the vacuum pump may be greater than about 40 percent and less than about 50 percent.

In some implementations, adjusting the duty cycle of the vacuum pump relative to the predetermined duty cycle may include limiting a number of adjustments of the duty cycle of the vacuum pump to a predetermined number during a given pill retrieval attempt.

In certain implementations, the method may further include, throughout at least a retrieval attempt of the pill, repeating the steps of receiving the pressure measurement signal (Sₚ) indicative of pressure in the nib, comparing pressure in the nib to the predetermined threshold pressure, and adjusting the duty cycle of the vacuum pump relative to the predetermined duty cycle.

### BRIEF DESCRIPTION OF THE DRAWINGS

FIG. 1A is a schematic representation of side cross-sectional view of a retrieval device.

FIG. 1B is a perspective view of the retrieval device of FIG. 1A.

FIG. 1C is a schematic representation of controlling vacuum pressure during retrieval and dispensing operation of the retrieval device of FIG. 1A.

FIG. 2 is a flow chart of an exemplary method for retrieval of dispensable units.

FIG. 3 is a schematic representation of a system for dispensable unit identification.

FIG. 4 is a flow chart of an exemplary method for dispensable unit identification.

FIGS. 5A-5C are flow charts of an exemplary method of controlling a vacuum system of a retrieval device for pills.

FIG. 6 is a flow chart of an exemplary method of removing debris from a vacuum system of a retrieval device for pills.

FIGS. 7A-7D are collectively, a schematic representation of a temporal sequence of operation of a retrieval device to remove debris from the nib according to the exemplary method of FIG. 6.

FIG. 8 is a flow chart of an exemplary method of controlling noise of a vacuum system in a retrieval device for pills.

FIG. 9 is a schematic graphical representation of a first duty cycle profile of a vacuum pump of the vacuum system of the retrieval device of FIG. 1A controlled according to the exemplary method of FIG. 8.

FIG. 10 is a schematic graphical representation of a second duty cycle profile of the vacuum pump of the vacuum system of the retrieval device of FIG. 1A controlled according to the exemplary method of FIG. 8.

FIG. 11 is a schematic graphical representation of a third duty cycle profile of the vacuum pump of the vacuum system of the retrieval device of FIG. 1A controlled according to the exemplary method of FIG. 8.

Like reference symbols in the various drawings indicate like elements.

### DETAILED DESCRIPTION

Embodiments will now be described more fully hereinafter with reference to the accompanying figures. The foregoing may, however, be embodied in many different forms and should not be construed as limited to the exemplary embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “above,” “below,” “top,” “bottom,” and the like, are words of convenience and are not to be construed as limiting terms.

While the following description provides detailed embodiments of methods, systems, and devices for managing dispensable units or items, e.g., consumables, it will be understood that the specific embodiments described herein are provided by way of example and not limitation, and that various aspects of this disclosure may have additional applications independent from those that are described. For example, the systems and methods described herein may be adapted to any environment where liquids, solids, powders, suspensions, and the like are controllably dispensed on any predetermined or ad hoc schedule such as a chemical, pharmaceutical or life sciences laboratory or a packaging facility for custom deliverables. All such variations are intended to fall within the scope of this disclosure.

### Definitions

The terms “item,” “unit,” “dispensable,” and related terms such as “dispensable unit,” “dispensable item,” and the like, are intended to refer broadly to any item, combination of items, composition, component, material, compound, object or the like that can be dispensed in unit or continuous form.

While a “dispensable” may be any item that can be dispensed, the term “consumable” or “consumable unit” is intended to refer to dispensables that are intended to be consumed by a user. Consumables are intended to include a wide array of ingestible consumable items and form factors for same. For example, consumable units may include one or more of pills, capsules, tablets, chewables, lozenges, dissolvables, sprinkles, dissolve-in-mouth micro-capsules, orally disintegrating tablets, chewable tablets (including jelly beans, gummies, and the like), gums, and so forth, as well as continuous form consumables such as liquids or powders, solutions, pastes, suspensions, and combinations thereof. The consumables may also or instead include items provided as free powders, powder sachets, liquids, liquid sachets, vials, cups, cases, other storage forms, and so forth. More generally, the consumable units may be any composition for consumption in bulk, individual, individual pre-packaged, group pre-packaged and/or mixed item package form. For bulk form compositions, the “consumable unit” may be a predetermined portion for dispensing such as a teaspoon of liquid, a number of pills, a milligram of powder or the like, or a similar predetermined portion for dispensing or mixing into a compound locally created for dispensing prior to or after dispensing. For bulk form compositions, the “consumable unit” may be a broken or separated piece of a continuous whole (e.g., chalk).

Similarly, the content of each consumable unit may vary significantly and may include but is not limited to prescription medication, non-prescription or over-the-counter medication, nutritional supplements, vitamin supplements, mineral supplements, veterinary medications, veterinary nutritional supplements, and so forth. Consumable units may also or instead include food and other items such as sugar, seeds, candies, snacks, pet treats, or other foods and the like, as well as any other pharmaceuticals, nutraceuticals, or other consumable items not identified above. These consumables that are intended to be ingestible are also referred to herein as “ingestibles” or “ingestible units.”

While consumables may include items for consumption in the conventional sense of ingestion as described above, consumables may also or instead include disposable items or the like that are intended for one time use. Thus, as used herein a “disposable” may be any consumable intended for a use other than ingestion. This may, for example, include disposable medical items such as dressings, bandages, Band-Aids, gauze, syringes, thermometers, individually packaged units of antibacterials and the like, as well as other items such as hearing aids, contact lenses and so forth that can be dispensed in individual units for one time use. This may also or instead include continuous form items not intended for ingestion including personal care items such as toothpaste, toothpicks, soap, sanitizer, moisturizer, cotton swabs and the like, as well as other household items such as glue, batteries, latex gloves, and so forth. All such disposables may be a form of consumable as those terms are used herein, and consumables may similarly be a form of dispensable.

It will be understood that while the foregoing terms (dispensable, consumable, ingestible, disposable) may be variously used in this disclosure to describe embodiments of the invention, the inventive concept generally applies to any and all such dispensables, and any description of one type of dispensable will be understood to refer to all such dispensables except where specifically noted to the contrary. Thus, for example, a container for consumable items will be understood to similarly teach a container for dispensable items, a container for ingestible items, and a container for disposable items. As another example, a schedule for delivery of a medical prescription will be understood to similarly teach a schedule for delivery of any dispensable, ingestible, consumable, and disposable, with suitable modifications being readily apparent to one of ordinary skill in the art.

Dispensable Retrieval Mechanism

An implementation includes a system having a retrieval device (which may also be referred to herein as a retrieval robot, retrieval mechanism, and the like) that is a pick-and-place mechanism for consistently picking up, separating, and/or breaking apart (collectively referred to herein as “retrieving,” “picking up,” and the like) dispensable units from a mixture of one or more dispensable units of arbitrary size, orientation, texture, color, weight, and so forth, whether disposed in a container or otherwise. In some embodiments, the retrieval process may be referred to herein as “plunging” and the like, where a retrieval robot or component thereof is “plunged” into a dispensable unit mixture. The dispensable unit may include any degree or measurement of any physical property, including but not limited to flexibility, rigidity, malleability, elasticity, and viscosity. The mixture of one or more dispensable units may not necessarily include identical units, nor does each dispensable unit need to be identical to another dispensable unit of the same type.

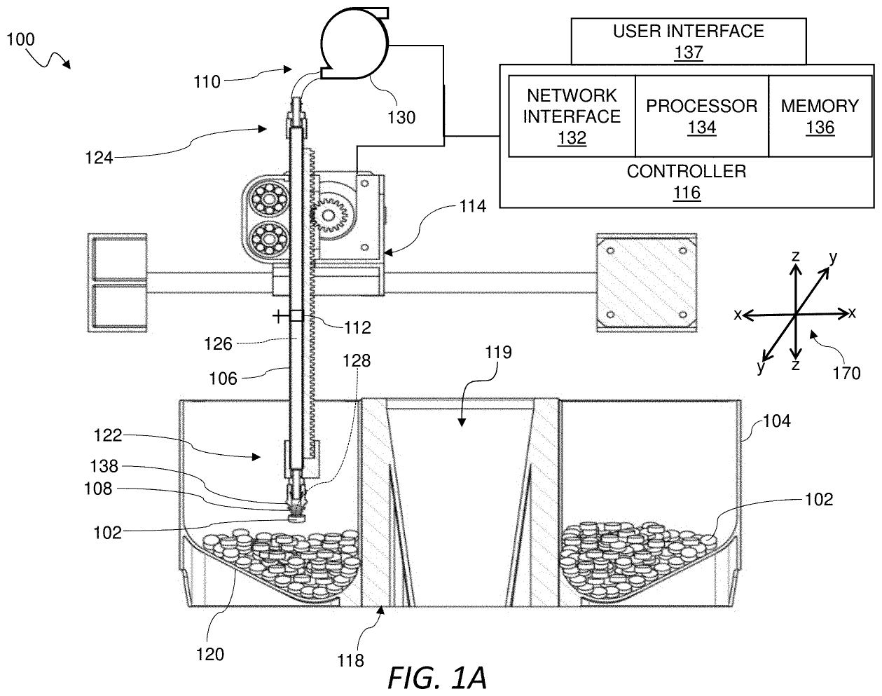

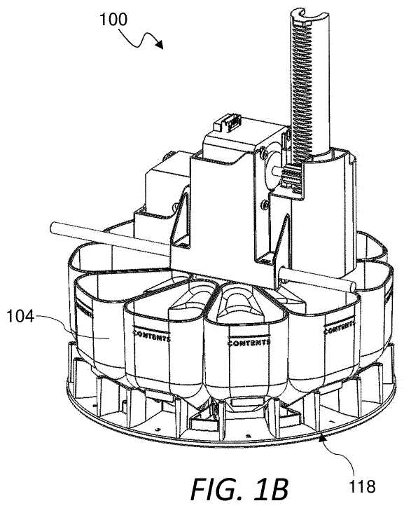

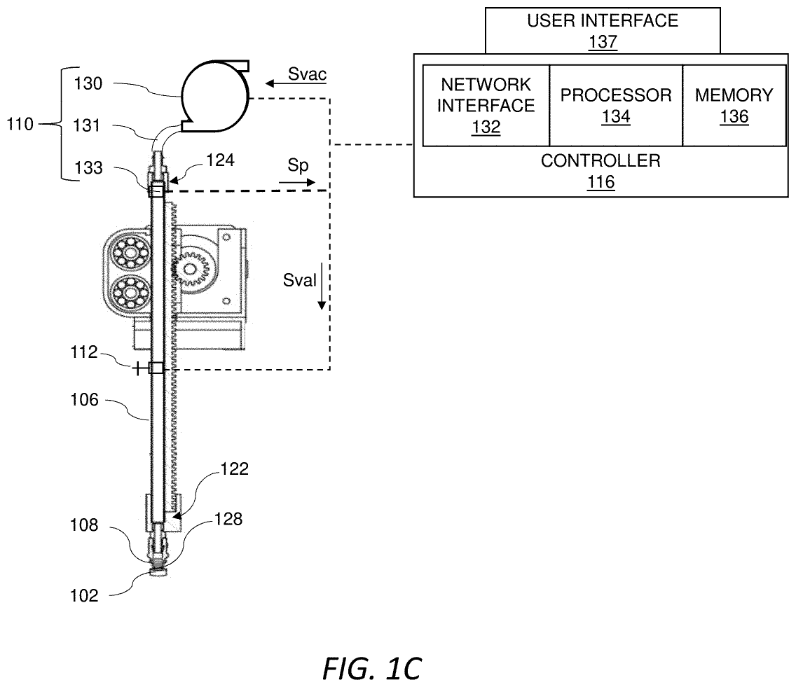

Referring now to FIGS. 1A-1C, a retrieval device 100 may, in general, include machinery and control software to enable the retrieval or pickup of dispensable units 102. As discussed herein, this may include blind retrieval in which hardware performs a predetermined sequence of moves according to a retrieval strategy without any use of machine vision or other similar techniques to locate and target an item for retrieval. The retrieval device 100 may allow for the retrieval of dispensable units 102 having any size, shape, color, texture, contour, weight, orientation, and so on. Additionally, using feedback and machine learning, the retrieval device 100 may learn improved parameters for retrieval across different types of dispensable units 102, or mixtures of dispensable units 102.

The retrieval device 100 may include a container 104, a tube 106 with a nib 108, a vacuum system 110, a valve 112, a positioner 114, and a controller 116. In one aspect, the container 104 is included on a carousel 118. The carousel 118 may include a plurality of containers 104, where the carousel 118 is movable for positioning at least one of the plurality of containers 104 relative to another component of the retrieval device 100, e.g., the nib 108, the tube 106, the positioner 114, and so on. For example, in an aspect, the carousel 118 is rotatable so that one of the plurality of containers 104 can be rotated into a position for engagement with the nib 108, which may itself have a limited range of motion within a horizontal plane. The carousel 118 may utilize the positioner 114 for its movement, or it may include an independent positioning mechanism. The positioning mechanism of the carousel 118 may include motors/actuators for automated movement or manual movement of the carousel 118 may be provided by a user or operator. Where one or more containers 104 are arranged around an axis of rotation of a rotatable carousel 118, the positioner 114 may achieve coverage of the entire projected surface of the container 104 with a combination of radial movement by the nib 108 and rotational movement by the carousel 118. Thus, in one aspect, general x-y positioning within a horizontal plane through one of the containers 104 can be affected through a combination of radial and rotational motion. In another aspect, the positioner 114 may provide x-y positioning coverage throughout the cross-section of a container 104, and the carousel 118 may be used to rotationally select from among a number of different available containers 104 on the carousel 118.

The tube 106 may have a first end 122 and a second end 124 coupled in fluid communication by a hollow core 126. The tube 106 may be flexible, rigid, or any combination thereof.

The nib 108 may be disposed on the first end 122 of the tube 106. The nib 108 may include an opening 128 with a perimeter and a seal around the perimeter formed of a pliable material shaped and sized to engage and form a vacuum seal with an object having a predetermined range of dimensions, e.g., a dispensable unit 102.

Because the shape and size of the dispensable units 102 may vary (i.e., between the same type of dispensable units 102 or between a mixture of different types of dispensable units 102), the predetermined range of dimensions may be a relatively wide range of dimensions. For example, in an aspect, the nib 108 can form a vacuum seal with small units such as less than 5 mm, and larger units such as greater than 150 mm.

The vacuum system 110 may include a vacuum pump 130 (e.g., a diaphragm pump) connected in fluid communication with the second end 124 of the tube 106. The vacuum pump 130 may provide a vacuum pressure in the hollow core 126 of the tube 106 such that the nib 108 at the first end 122 of the tube 106 can draw dispensable units 102 in its immediate environment for engagement via the force provide by a pressure difference from inside the tube 106 to outside the tube 106. In an aspect, the vacuum system 110 is capable of reversing the direction of air flow, e.g., provided by the vacuum pump 130. The direction of the air flow may be reversed, for instance, using a branching line with one or more solenoid valves or using a reversible air pump. Reversing the direction of air flow may allow for the removal of any contaminants that are present (e.g., attached to a filter or the like within the tube 106) in components of the retrieval device 100, or otherwise for the removal of objects obstructing air flow in non-reversed operation of the retrieval device 100.

The valve 112 may be disposed between the nib 108 and the vacuum system 110, where the valve 112 is operable to controllably apply a vacuum force from the vacuum pump 130 through the hollow core 126 to the nib 108. The valve 112 may provide for a suction state when in a first position and a releasing state when in a second position. In the first position, the valve 112 may be open, where the vacuum system 110 maintains a fluid connection with the first end 122 of the tube 106. In the second position, the valve 112 may be closed, where the valve 112 cuts off fluid communication of the vacuum system 110 and the first end 122 of the tube 106. Alternatively, the valve 112 may otherwise provide for a break in the fluid connection between the vacuum system 110 and the first end 122 of the tube 106, where a break in the fluid connection equalizes pressure within the tube 106 and its external environment. To assist with the pressure equalization and thus the speed with which the connection of a dispensable unit 102 is severed, the vacuum system 110 may be turned off at the same time as switching the valve 112 to its releasing state. Such a valve 112 may be controlled automatically, e.g., by a signal received from the controller, or manually. In an aspect, the valve 112 includes a solenoid valve or the like.

The positioner 114 may be coupled to the tube 106 and configured to move the nib 108 with at least two degrees of translational freedom within the container 104. In an aspect, the positioner 114 is able to move the nib 108 with three degrees of translational freedom within the container 104, e.g., an x-axis and a y-axis for horizontal positioning within the container 104, and a z-axis for lowering into the container 104 to attempt a retrieval at a particular x-y location. In another aspect, the positioner 114 may provide two degrees of translational freedom, e.g., an x-axis and the z-axis, while rotation of the carousel 118 provides a third degree of freedom for arbitrary positioning of the nib 108 relative to the container 104. Other arrangements may also or instead be used. For example, the carousel 118 may be vertically movable to provide a translational degree of freedom along the z-axis, or the positioner 114 may be movable radially and rotationally on an arm extending from an axis of the carousel 118. More generally, any arrangement of positioning mechanisms suitable for arbitrarily positioning the nib 108 within the coordinate system of the container 104 may be suitably employed as the positioner 114 and/or carousel 118 as contemplated herein.

In an aspect, movement of the mixture of disposable units 102 relative to the tube 106 is accomplished through movement of the container 104.

The controller 116 may be coupled in a communicating relationship with one or more mechanical components of the retrieval device 100, e.g., the vacuum system 110, the valve 112, and the positioner 114. The controller 116 may be configured to operate the nib 108 to attempt a blind retrieval of a number of dispensable units 102 within the container 104 using a sequence of retrieval attempts each applying a different two-dimensional retrieval pattern within a first horizontal plane through the container 104. The controller 116 may also provide for the retrieval device 100 to attempt other retrieval patterns, e.g., a one-dimensional retrieval pattern and a three-dimensional retrieval pattern.

The controller 116 may include any hardware or software to provide programming as described herein. Those skilled in the art will recognize that a variety of different controllers 116 may be used in the implementations described herein. The controller 116 may be programmable and include a network interface 132, a processor 134, a memory 136, and any other hardware or software to perform its functions as described herein. A user interface 137 may be in electrical communication with the controller 116. In certain instances, the user interface 137 may receive input from a user. Further, or instead, the user interface 137 may be used to display errors associated with unsuccessful dispensing and/or provide an indication of a successful dispensing event.

Although the retrieval device 100 in the figure is shown as a vertically-aligned retrieval device, where the two-dimensional retrieval pattern is discussed as being through a horizontal plane, one skilled in the art will recognize that other alignments are also or instead possible. For example, in another aspect, the device is a horizontally-aligned retrieval device, where the two-dimensional retrieval pattern is through a vertical plane. Other alignments, e.g., tilted or angled alignments are also possible. Still more generally, while an x, y, z coordinate system 170 generally serves as a convenient basis for positioning within three dimensions and are included in some of the discussions regarding positioning herein, any other coordinate system or combination of coordinate systems may also or instead be employed, such as a positional controller and assembly that operates according to cylindrical or spherical coordinates.

In general, in use, the retrieval device 100 may involve the tube 106 with the nib 108 being plunged (e.g., vertically or substantially vertically, horizontally or substantially horizontally, or otherwise) into a mixture of disposable units 102. This actuation may occur using the positioner 114 as described herein. Upon contact between the nib 108 and a disposable unit 102 (e.g., on the surface of the mixture or near the surface of the mixture), suction caused by the pressure difference between tube 106 and the external environment may draw the disposable unit 102 to the nib 108, where the nib 108 forms a sealed connection with the disposable unit 102. The disposable unit 102 may thus be held by the tube 106 due to the force of the vacuum pressure, which is selected to be sufficiently strong to keep the disposable unit 102 connected to the nib 106 against the force of the weight of the disposable unit 102 and any disturbing or resistive forces such as that imposed by other disposable units 102 nearby, heavy vibrations, movement of the nib 108 or tube 106, or otherwise.

Once the connection with the disposable unit 102 has been made, the positioner 114 may retract the tube 106 from the container 104, e.g., pull the tube 106 up along the z-axis in the vertically-aligned device shown in the figure. Due to the engagement, the disposable unit 102 may travel with the tube 106 from a position above the container 104 to a position above a chute 119, where the pill be dispensed to a user. Upon a signal, e.g., from the controller 116, the engagement may be broken, thus releasing the disposable unit 102, which may fall due to, e.g., its own weight, an artificially applied field (e.g., magnetic field), or similar. The engagement between the nib 108 and the disposable unit 102 may be broken, e.g., by turning off the vacuum pump 130, by releasing a mechanical grabber, by operation of the valve 112, and the like.

In certain implementations, the retrieval device 100 may include a carousel 118 including a plurality of containers 104 arranged for substantially vertical retrieval of dispensable units contained in one or more of the plurality of containers 104. For example, each of the containers 104 may include distinct and separate dispensable unit mixtures. The carousel 118 may be arranged substantially in a circle in a horizontal plane. The carousel 118 may rotate as necessary to select different containers 104 and, thus, different dispensable unit mixtures. To reduce the likelihood of contamination, there may be a cover for the containers 104, e.g., that covers all containers 104 except for the container 104 selected for dispensable unit retrieval (i.e., the container 104 that the tube 106 is disposed above). The cover may be movable, e.g., rotatable about the containers 104.

Vacuum Control

In general, the vacuum pump 130 may be in fluid communication with the tube 106 using any one or more of various different types of hardware. For example, the vacuum system 110 may include tubing 131 (e.g., hoses, pipes, etc.) connecting the vacuum pump 130 in fluid communication with the first end 122 of the tube 106 via the second end 124 of the tube 106. The tubing 131 may be flexible to facilitate moving the tube 106 relative to the vacuum pump 130 during a retrieval and dispensing operation while maintaining a tight seal between the tubing 131 and the vacuum pump 130 and between the tubing 131 and the second end 124 of the tube 106.

The vacuum system 110 may additionally, or alternatively, include one or more pressure sensors 133 positioned to measure one or more signals indicative of vacuum pressure in the tube 106. While the pressure sensor 133 is depicted as being located near the second end 124 of the tube 106, the pressure sensor 133 may be located at other locations along the tube 106, and/or in fluid communication with, the tube 106. Further or instead, while a single instance of the pressure sensor 133 is shown, it shall be appreciated that this is for the sake of clear and efficient description and that a plurality of instances of the pressure sensor 133 may be located at different locations on, and/or in fluid communication with, the tube 106. For example, the vacuum system 110 may include respective instances of the pressure sensor 133 along the first end 122 of the tube 106 and along the second end 124 of the tube 106. The pressure sensor 133 may include, for example, a pressure transducer that generates a pressure measurement signal Sp indicative of vacuum pressure in the tube 106. The pressure sensor 133 may be in electrical communication (e.g., wired or wireless communication) with the controller 116. The controller 116 may receive the pressure measurement signal Sp and, in certain instances, may store the pressure measurement signal Sp as data in the memory 136.

The controller 116 may control, among other things, the vacuum pressure in the tube 106 by controlling the vacuum pump 130, the valve 112, or a combination thereof. Unless otherwise specified or made clear from the context, it shall be appreciated that the memory 136 may have stored thereon computer-readable instructions for causing the processor 134 to carry out the various different operations associated with the controller 116 controlling the vacuum pressure in the tube 106.

The controller 116 may generate a vacuum control signal Svac and send the vacuum control signal Svac to the vacuum pump 130. The vacuum control signal Svac may control one or more aspects of operation of the vacuum pump 130 (e.g., on/off, duty cycle, etc.). The controller 116 may further, or instead, generate a valve control signal Sval and send the valve control signal Sval to the valve 112. The valve control signal Sval may control operation of the valve, such as by switching the valve 112 between an open state and a closed state. In one or more aspects, the valve 112 may include a proportional control valve, in which case the valve control signal Sval may control a degree of the opening of the valve 112.

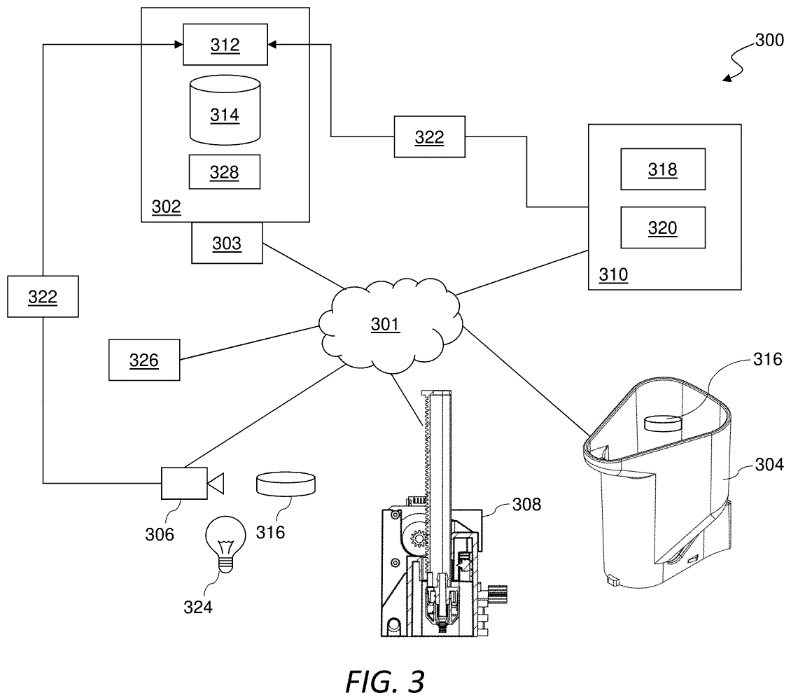

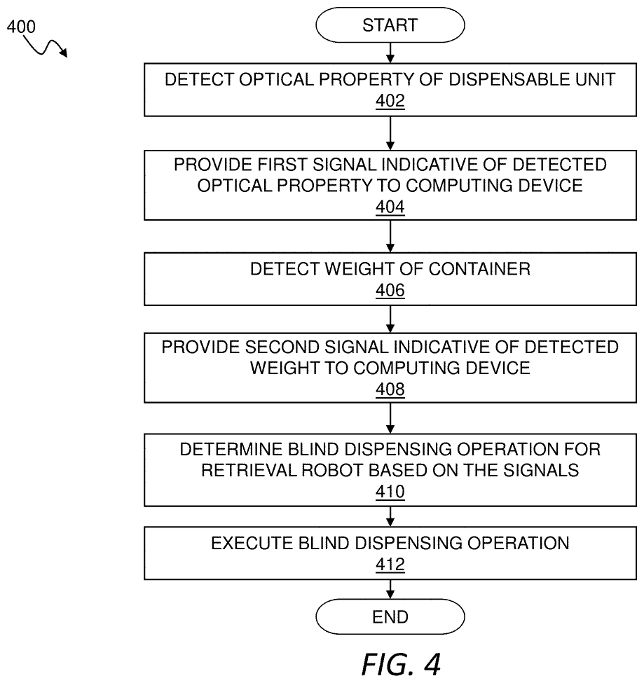

The controller 116 may generate the vacuum control signal Svac, the valve control signal Sval, or a combination thereof, based at least in part on the the pressure measurement signal Sp received from the pressure sensor 133. In certain instances, the vacuum control signal Svac may be further, or instead, based on data stored in the memory 136. The data stored in the memory 136 may include, for example, weight data, texture data, shape data, or size data associated with various pills (e.g., dispensable units) that may be retrieved by the retrieval device 100. Such data may be accessed by the controller 116, for example, by a connection to the data network 401 of the system 400 for dispensable unit identification (FIG. 4). The connection to the data network 301 (FIG. 3) may allow the controller 116 to access data stored in the memory 314 (FIG. 3) of the computing device 302 (FIG. 3), and store the data in the memory 136.

In certain implementations, the memory 136 may additionally, or alternatively, have stored thereon one or more vacuum control algorithms for controlling the vacuum system 110 during a retrieval and dispensing operation. Additionally, or alternatively, the memory 136 may have stored thereon one or more data tables including data associated with carrying out one or more aspects of the vacuum control algorithms. Such data may include, for example, pressure data associated with the dynamic adjustment of retrieval and dispensing parameters described above. Such pressure data may include, for example, Pₒₚₑₙ, P_{pick}, Pₛₑₐₗ and Pₕₑₐₗₜₕ. The data stored in the memory 136 may be accessed by the processor 134, allowing the processor 134 to execute the vacuum control algorithms and, more generally, perform various operations on the data (e.g., arithmetic operations, manipulation, updating, etc.) according to the computer-readable instructions stored in the memory 136.

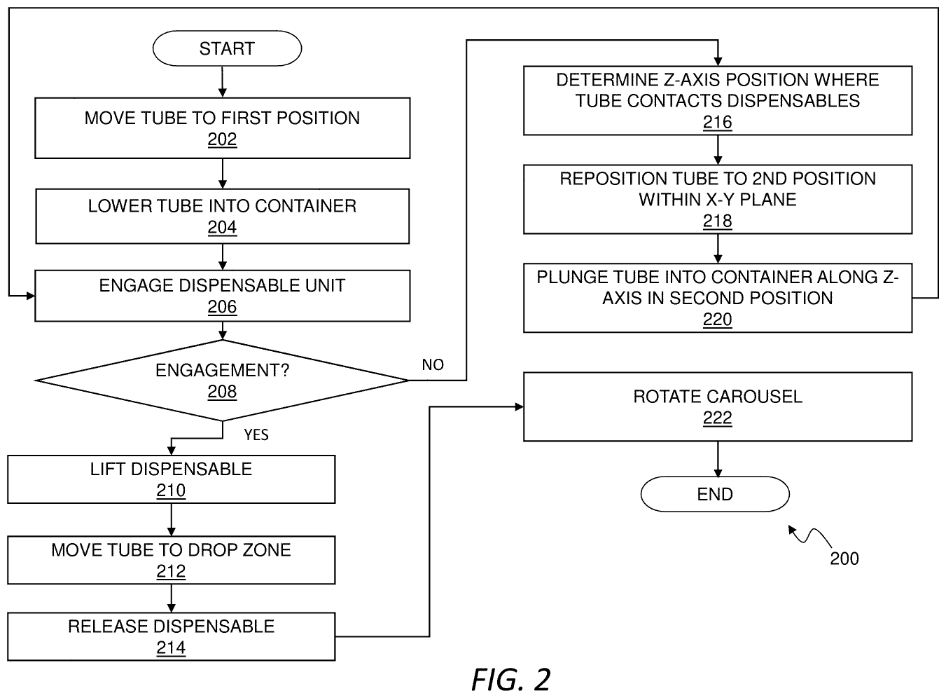

FIG. 2 is a flow chart of an exemplary method 200 for retrieval of dispensable units.

As shown in step 202, the exemplary method 200 may include positioning a tube in a first position in an x-y plane for cooperation with a container including a plurality of dispensable units. Unless otherwise specified or made clear from the context, it shall be understood that any one or more of the various different aspects of the exemplary method 200 may be carried out using any one or more of various different aspects of the retrieval device 100 (FIG. 1A), including the controller 116 (FIG. 1A) in electrical communication with the positioner 114 (FIG. 1A), the valve 112 (FIG. 1A), the vacuum pump 130 (FIG. 1A). For example, the memory 136 (FIG. 1A) may be one or more non-transitory computer-readable storage media having stored thereon instructions for causing the processor 134 (FIG. 1A) to carry out one or more aspects of the exemplary method 200.

As shown in step 204, the exemplary method 200 may include moving the tube into the container along a z-axis in the first position such that a first end of the tube contacts one or more of the plurality of dispensable units.

As shown in step 206, the exemplary method 200 may include actuating an engagement mechanism to create an engagement between the first end of the tube and one of the dispensable units. The engagement mechanism may include a vacuum force exerted through an opening in a nib on the first end of the tube, a mechanical grabber, and so forth. For example, in one aspect, in addition to or lieu of a vacuum system, the device may use an articulating claw, grasper, or other electromechanical device suitable for retrieving dispensable units.

As shown in step 208, the exemplary method 200 may include determining whether engagement between the first end of the tube and the dispensable unit is achieved. Determining whether the engagement is achieved may include the use of one or more sensors, e.g., optical sensors, pressure sensors, weight sensors, force sensors, contact sensors, and so on. If engagement is achieved the exemplary method 200 may move onto step 210, and if not, the exemplary method 200 may move onto step 216 or another step in the exemplary method 200, such as step 218.

As shown in step 210, the exemplary method 200 may include lifting the dispensable unit, e.g., by moving the tube along the z-axis or otherwise operating the retrieval device to move the dispensable unit vertically from the mixture. For example, the tube may be retracted in a direction normal to the surface of the dispensable unit mixture, or it may be retracted at an angle relative to the surface of the dispensable unit mixture, or the tube may include an actuator or the like to raise the nib without moving the tube or other components of the retrieval device.

As shown in step 212, the exemplary method 200 may include moving the tube until the dispensable unit is disposed within a predetermined drop zone. This may, for example, include moving the tube along the x-y plane substantially perpendicular to the z-axis until a desired horizontal position is reached, or moving in any combination of x, y, and z steps to navigate the end of the tube to a desired location. For example, moving the tube may also be accomplished at an angle or other trajectory that includes movement along all three axes, or alternatively, the z-axis and at least one of the x-axis and y-axis.

As shown in step 214, the exemplary method 200 may include releasing the dispensable unit from its engagement with the first end of the tube, e.g., by breaking a bond or connection between the dispensable unit and the retrieval device.

As shown in step 216, the exemplary method 200 may include determining a z-axis position where the first end of the tube contacts one or more of the plurality of dispensable units.

As shown in step 218, the exemplary method 200 may include repositioning the tube to a second position different from the first position within the x-y plane.

As shown in step 220, the exemplary method 200 may include plunging the tube into the container along the z-axis in the second position.

The steps 202 through 220 may be performed any number of times according to a number of dispensable units that are to be retrieved from a container. This may include a single retrieval or a number or retrievals, or a continuous retrieval of numerous dispensable units until a stopping condition is reached.

As shown in step 222, the exemplary method 200 may include rotating a carousel including a plurality of containers for positioning at least one of the plurality of containers relative to the tube. In this manner, the retrieval device may be used with a number of different containers so that a variety of different dispensable units can be controllably dispensed from a system in any desired combination or order. The containers may be arranged radially around the retrieval device in a carousel so that the carousel can be rotated to move one of the containers into an operating region of the retrieval device, or the containers may be arranged linearly or in any other suitable pattern, along with accompanying robotics or the like to move one of the containers into a position where the retrieval device can retrieve dispensable units.

Dispensable Unit Identification

Referring now to FIG. 3, a system 300 may include components and participants for detecting one or more properties of a dispensable unit. The system 300 may include a computing device 302, a container 304, an optical sensor 306, a retrieval robot 308, and a measurement device 310. The aforementioned participants and components of the system 300 may be in a communicating relationship with one another, e.g., through a data network 301.

Communications over the data network 301 may be made possible through one or more communications interfaces 303 present on one or more of the components of the system 300. The communications interface 303 may include, or be connected in a communicating relationship with, a network interface or the like. The communications interface 303 may include any combination of hardware and software suitable for coupling the components of the system 300 to a remote device (e.g., the computing device 302) in a communicating relationship through the data network 301. The computing device 302 may include a processor 312 and a memory 314. The computing device 302 may generally provide a user interface 328, which may include a graphical user interface, a text or command line interface, a voice-controlled interface, and/or a gesture-based interface. The container 304 may be any as described herein, and may for instance be shaped and sized to hold a plurality of dispensable units 316.

The optical sensor 306 may be configured to detect an optical property of one of the plurality of dispensable units 316 prior to placement in the container 304. The optical sensor 306 may include one or more of the following: a CMOS device, a CCD device, an opto-interrupter, a reflective object sensor, and the like. The optical property detected by the optical sensor 306 may include without limitation one or more of a texture of the dispensable unit 316, a shape of the dispensable unit 316, and a size of the dispensable unit 316, and so on.

The retrieval robot 438 may be any as described herein, and may for instance be configured to retrieve objects from within the container 304, e.g., the dispensable units 316.

The measurement device 310 may include a strain gauge 318 and circuitry 320 configured to provide a signal 322 indicative of a detected weight of one or more of the container 304 and a dispensable unit 316. For example, in an aspect, the measurement device 310 provides a detected weight of one or more of the plurality of dispensable units 416 prior to placement in the container 304. In an aspect, the detected weight of the container 304 yields the weight of the dispensable units 316 within the container when the weight of the container 304 is known. In another aspect, when the weight of the container 304 and the weight of an individual instance of the dispensable units 316 (or the weight of a certain amount of dispensable units 316) is known, the detected weight of the container 304 yields the amount of the dispensable units 316 within the container 304. A suitably sensitive instance of the measuring device 310 may also provide additional information, such as when a single dispensable is removed, how much contact force a retrieval device is applying to the container, and how many items are left in the container. This information can facilitate a blind retrieval task as contemplated herein by providing non-optical feedback useful in planning and executing a retrieval strategy.

The measurement device 310 may also or instead include one or more cantilevers for supporting the container 304, e.g., a platform of similar size to the containers 304. The cantilever may be attached such that a force (e.g., including, but not limited to, weight) on the cantilever causes a deformation. On such a measurement device 310, a user may activate a “measurement mode” or the like, or it may be activated automatically. Upon activation of a measurement mode, the measurement device 310 may measure the weight of a container 304 (empty or otherwise) and store that data in a memory 314. In an aspect, the weight of the container 304 and the known weight of a dispensable unit 316 may be used to calculate an amount of dispensable units 316 present in the container 304 at a given time.

The processor 312 may be configured to receive the signal 322 and to use the detected weight and the optical property to execute a blind dispensing operation of one of the plurality of dispensable units 316 from the container 304 using the retrieval robot 308. In one aspect, the processor 312 is part of a controller or the like (e.g., as described above), or the processor 312 is in communication with the controller, for controlling operation of the retrieval robot 308.

In an implementation, the optical sensor 306 is configured to detect an optical property of a portion or group of the plurality of dispensable units 316, and the processor 312 is configured to determine whether the portion of the plurality of dispensable units 316 includes dispensable units 416 of different types based on the optical property of the portion.

FIG. 4 is a flow chart of an exemplary method for dispensable unit identification.

As shown in step 402, the exemplary method 400 may include detecting an optical property of a dispensable unit. This may usefully be performed prior to placement of the dispensable unit in a container that is shaped and sized to hold a plurality of dispensable units for distribution using a device as contemplated herein. An optical sensor or the like may be used to detect the optical property of the dispensable unit.

Detecting an optical property of a dispensable unit may include illuminating the dispensable unit with a light source that produces a light having a plurality of frequencies; measuring diffusion, dispersion, and strength of light returned to an optical sensor; and detecting a texture of the dispensable unit from the measured diffusion, dispersion, and strength.

Detecting an optical property of a dispensable unit may also or instead include using light obstruction, e.g., for detecting at least one of a size and shape of the dispensable unit. For example, the device may determine the size of the dispensable unit based on how much light is obstructed from an array of LEDs shining at the dispensable unit. The LEDs may also or instead send an amplitude or frequency modulated signal, whose receipt may be Fast Fourier Transformed (FFT) by the sensors to determine the amount of light obstruction. Detecting an optical property of a dispensable unit may also or instead include machine vision, i.e., edge detection of dispensable unit's edges in a two-dimensional image, or use of side-lighting to detect surface features or textures.

The exemplary method 400 may also include detecting an optical property of numerous dispensable units in a group, and determining whether this group of dispensable units includes dispensable units of different types based on the optical properties of the group and individual items in the group.

As shown in step 404, the exemplary method 400 may include providing a first signal to a computing device including a processor and a memory, the first signal indicative of the detected optical property.

As shown in step 406, the exemplary method 400 may include detecting a weight of one or more of the container and a dispensable unit using a measurement device.

As shown in step 408, the exemplary method 400 may include providing a second signal to the computing device, the second signal indicative of the detected weight of the container.

As shown in step 410, the exemplary method 400 may include determining a blind dispensing operation for retrieving one of the plurality of dispensable units from the container with a retrieval robot using information included in at least one of the first signal and the second signal. The blind dispensing operation may include executing a retrieval pattern as discussed herein. Thus, determining the blind dispensing operation may include determining the use of a specific retrieval pattern, determining steps for a retrieval pattern, formulating a retrieval pattern from scratch, adjusting a retrieval pattern, and so forth. Determining the blind dispensing operation may also or instead include determining other parameters for retrieval include speed, acceleration, trajectories, drop zones, cleaning schedules or procedures, and so forth.

As discussed generally herein, optical and weight information may be used in a variety of ways. For example, the weight may be used to determine how many units are in a container or when the container might be empty. Weight may also be used to quickly check for a successful retrieval attempt, or to measure the force that a retrieval device is applying to items in a container. The optical properties may be used, e.g., to estimate a contact force and/or vacuum force required to securely bind a dispensable unit with a vacuum-based retrieval nib. In another aspect, the optical properties may be used to estimate size or weight of individual units, so that a sufficient vacuum force can be applied, and so that retrieval attempts (e.g., included in a sequence) are spaced a suitable distance apart. More generally, any use of weight and optical properties as contemplated herein may be used to augment and improve a blind retrieval process and eliminate or mitigate the need for machine vision or similar image analysis as an aid to navigation during retrieval.

As shown in step 410, the exemplary method 400 may include executing the blind dispensing operation.

The exemplary method 400 may also or instead include performing error checks. An error check may include determining whether the weight of the dispensable units that was measured is a multiple of the weight of an originally measured dispensable unit (within a certain margin of error). Another error check may use one or more cameras disposed within a container for viewing the dispensable units from a variety of angles to ensure that the visible added dispensable units have the same or similar properties, and to ensure that no residue or other contaminant is present in the container. This may be coupled with a vibration actuation (e.g., via a motor or the like) of the container to agitate the dispensable units, e.g., for exposing more dispensable units for the line of sight of the camera for verification. Notifications to a user (or another component or participant in the system) may be sent based on the outcome of the error checks.

Having described devices, systems, and methods that include vacuum-based retrieval and dispensing of dispensable units, attention is now directed to certain aspects of actively controlling such vacuum-based retrieval and dispensing of dispensable units. In general, as compared to vacuum-based retrieval that is not subject to active control, the following active control techniques facilitate more efficient retrieval. In this context, such efficient retrieval may include, for example, one or more of reductions in retrieval time, more robust retrieval across a wider range of conditions, sustained retrieval effectiveness over time, or reduction in pump wear. Unless otherwise specified or made clear from the context, any one or more of the various different techniques described below may be carried out using the hardware described above with respect to FIGS. 1A, 1B, 1C, and 3 and may be carried out in addition to or instead of any one or more of the various different methods described above with respect to FIG. 2 or FIG. 4. Further, while certain aspects of the retrieval device 100, the exemplary method 200, the system 300, and the exemplary method 400 have been described, additional or alternative aspects of these devices, systems, and methods are described in U.S. Pat. No. 9,731,853 B2, issued Aug. 15, 2017, and entitled “NETWORKED NOTIFICATION FOR DISPENSABLE UNITS,” the entire contents of which are hereby incorporated herein by reference.

In the description that follows, the convention used to describe vacuum pressure is that larger amounts of vacuum pressure correspond to lower (more negative) differential pressure, and lower amounts of vacuum pressure correspond to higher (more positive) differential pressure. Thus, for example, −35 kPa shall be understood to be a lower differential pressure than −25 kPa. Unless otherwise specified or made clear from the context, any one or more of the various different pressure measurements described below shall be understood to be carried out using a pressure sensor in fluid communication with the vacuum system to measure pressure between the nib and the vacuum system. For the sake of clarity, the implementations that follow are described with respect to the use of differential pressure. To the extent specific differential pressure values are used, it shall be understood that these values are used for the sake of explanation of certain relationships between parameters and shall not be understood to be limiting, particularly given that such numerical values may vary based on particular system hardware. Further, or instead, it shall be appreciated that any one or more of the various different pressure measurements described below may include absolute pressure measurements, such as may be useful for accounting for the impact of altitude on performance of the vacuum system.

Further, in the description that follows, the various different techniques are described in terms of pill retrieval for the sake of clear and efficient description. It shall be appreciated, however, that any one or more of the various different dispensable units described herein may be retrieved and dispensed according to these techniques, unless otherwise specified or made clear from the context.

Dynamic Adjustment of Retrieval and Dispensing Parameters

In general, as a pill is retrieved and dispensed, the system may compare one or more readings from one or more pressure sensors against threshold values associated with states of the retrieval and dispensing processes. However, one or more portions of the vacuum system may degrade through normal use. Such degradation may occur, for example, through wear on hardware components and/or as one or more vacuum filters in the system become clogged with dirt or other debris. As such degradation occurs, the vacuum system may nevertheless remain capable of retrieving and dispensing dispensable units according to the various different techniques described herein. However, it may be useful to account for such degradation to facilitate efficiency of retrieval and dispensing of the dispensable units above a certain threshold acceptable for system performance and, ultimately, to meet consumer expectations. Thus, in some implementations, it may be useful to change one or more control parameters of the vacuum system dynamically to account for changes in performance of the vacuum system that may occur over time—whether through normal wear and tear, accumulation of debris, changes in ambient conditions, or other parameters that may vary considerably across systems deployed in the field. For example, as described in greater detail below, such dynamic variation in one or more pressure parameters used to control the vacuum system may account for changes in system conditions and, in doing so, may reduce the likelihood of false errors that would otherwise occur through the use of static control parameters.

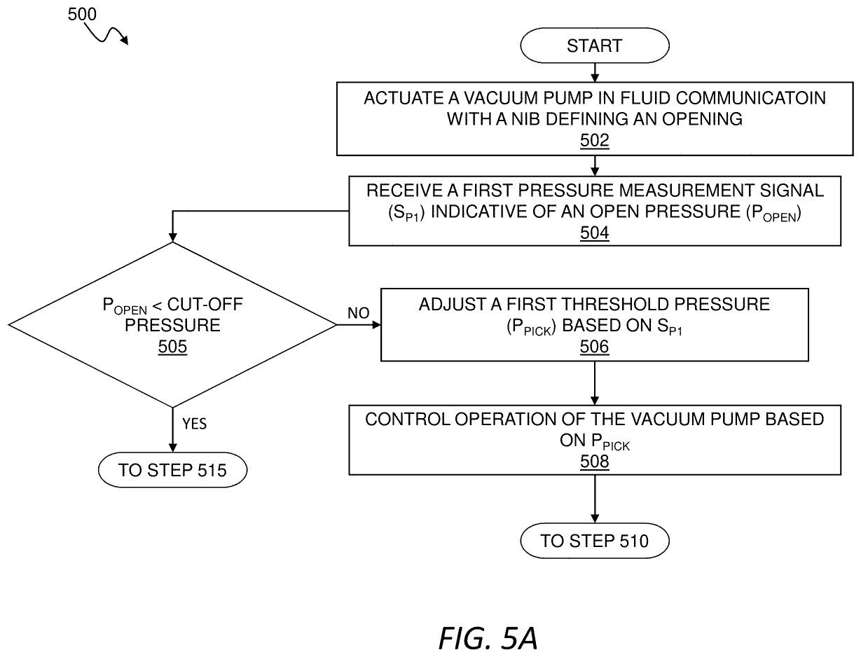

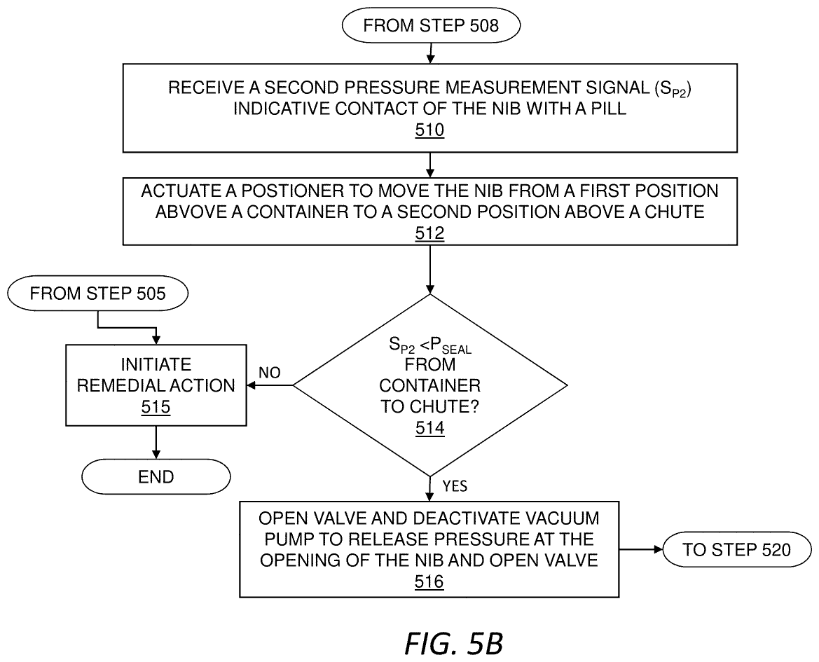

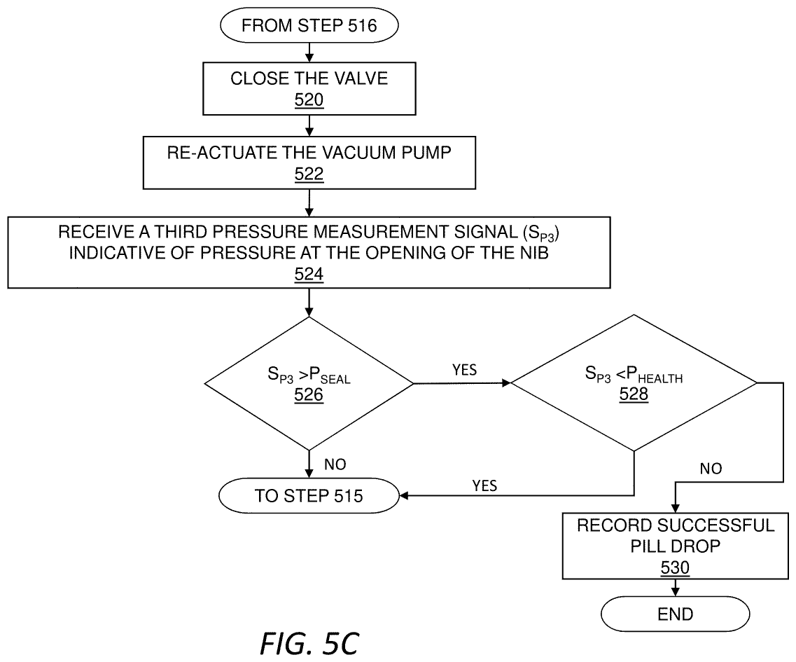

FIGS. 5A-5C are flow charts of an exemplary method 500 of controlling a vacuum system of a retrieval device for pills. Unless otherwise specified or made clear from the context, it shall be understood that any one or more of the various different aspects of the exemplary method 500 may be carried out using any one or more of various different aspects of the retrieval device 100 (FIG. 1A), including the controller 116 (FIG. 1A) in electrical communication with the positioner 114 (FIG. 1A), the valve 112 (FIG. 1A), and the vacuum pump 130 (FIG. 1A). For example, the memory 136 (FIG. 1A) may be one or more non-transitory computer-readable storage media having stored thereon instructions for causing the processor 134 (FIG. 1A) to carry out one or more aspects of the exemplary method 500.

As shown in step 502, the exemplary method 500 may include actuating a vacuum pump in fluid communication with a nib defining an opening. As used in this context, actuating the vacuum pump may include turning the vacuum pump on or increasing power to the vacuum pump from a lower power setting. Having the vacuum pump initially in an off state and turning the vacuum pump on may be useful for reducing noise and power required for pill dispensing and performing diagnostics on the vacuum system. Further, or instead, increasing power to the pump from a lower power setting may be useful for reducing changes in noise and/or may facilitate faster responsiveness of the vacuum pump.

As shown in step 504, the exemplary method 500 may include receiving a first pressure measurement signal (Sₚ₁) indicative of an open pressure (Pₒₚₑₙ) of the nib with the vacuum pump actuated and the opening unobstructed by material external to the nib. The first pressure measurement signal (Sₚ₁) may be a signal received, for example, from a pressure sensor (e.g. the pressure sensor 133 in FIG. 1A). For the sake of clear and efficient explanation, the pressure measurement signals described herein may be used interchangeably with the pressures represented by such measurement signals. It shall be appreciated, however, that the pressure measurement signals may be received in a raw form and may be further processed according to any one or more of various different signal processing techniques known in the art to provide a pressure measurement.

As shown in step 505, the exemplary method 500 may include comparing the open pressure (Pₒₚₑₙ) to a predetermined cut-off pressure (e.g., a hard-coded value) and initiating a remedial action (as described in greater detail below) if the open pressure (Pₒₚₑₙ) is below the predetermined cut-off pressure. That is, at low enough values, the open pressure (Pₒₚₑₙ) may be indicative of severe blockages that are beyond normal operating limits and require maintenance. For example, detection of the open pressure (Pₒₚₑₙ) below the cut-off value may result in a remedial action including aborting the attempt to dispense a pill and/or flagging an error condition (e.g., flagging diagnosis on a server for remote debugging). This may spare the user from wasting time in waiting for a dispensing attempt that is unlikely to be successful in view of the severity of clogging detected.

As shown in step 506, the exemplary method 500 may include, based on the first pressure measurement signal (Sₚ₁), adjusting a first threshold pressure (P_{pick}) indicative of a pressure below which the opening of the nib is in at least partial sealed engagement with a pill. That is, the first threshold pressure (P_{pick}) is indicative of pressure at the opening of the nib as the opening initially encounters a pill. This first threshold pressure (P_{pick}) may be adjusted based on the open pressure (Pₒₚₑₙ). Such dynamic adjustment of the first threshold pressure (P_{pick}) may, for example, facilitate maintaining proper operation of the vacuum system, even as one or more vacuum filters become partially clogged over time. In particular, as compared to the use of a static threshold value for the first threshold pressure (P_{pick}), one or more partially clogged filters in the vacuum system are less likely to be falsely interpreted as a pill pick-up when the first threshold pressure (P_{pick}) is adjusted based on the open pressure (Pₒₚₑₙ). That is, by modifying the first threshold pressure (P_{pick}) based on the open pressure (Pₒₚₑₙ), the control of the vacuum system may take into consideration gradual degradation of the vacuum system, such as may occur as dirt and/or debris builds up on or more filters. As a specific example, the first threshold pressure (P_{pick}) may be about −25 kPa differential pressure for a vacuum system in which the open pressure may be about −3 kPa differential pressure. As the vacuum system becomes clogged over time, the open pressure (Pₒₚₑₙ) may drop to about −25 kPa differential pressure. Without dynamic adjustment of the first threshold pressure (P_{pick}) to account for this change in the open pressure (Pₒₚₑₙ), the control system may be more likely to falsely interpret the open pressure (Pₒₚₑₙ) resulting from clogging as a pill pick-up. Thus, to reduce the likelihood of such an error in the foregoing example, the first threshold pressure (P_{pick}) may be adjusted dynamically based the measured value of the first open pressure (Pₒₚₑₙ), to reflect that the vacuum pump must work harder in view of the clogging. For example, when the open pressure (Pₒₚₑₙ) is −25 kPa differential pressure, the first threshold pressure (P_{pick}) may be adjusted to −35 kPa such that only pressure below −35 kPa will be interpreted to correspond to a pill pick up.

In general, the first threshold pressure (P_{pick}) may be related to the open pressure (Pₒₚₑₙ) according to any one or more of various different predetermined relationships, provided that such a relationship adjusts the first threshold pressure (P_{pick}) to correspond to a pressure less than the open pressure (Pₒₚₑₙ). Thus, for example, the relationship between the first threshold pressure (P_{pick}) and the open pressure (Pₒₚₑₙ) may be an empirical relationship useful for decreasing the likelihood that the open pressure (Pₒₚₑₙ) may be falsely interpreted as a pill pick up. Further, or instead, the relationship between the open pressure (Pₒₚₑₙ) and the first threshold pressure (P_{pick}) may be linear (e.g., P_{pick}=m*Pₒₚₑₙ+b) at least over a portion of a range of pressures. Additionally, or alternatively, the relationship between the open pressure (Pₒₚₑₙ) and the first threshold pressure (P_{pick}) may be a function of altitude. For example, under otherwise identical conditions, the first threshold pressure (P_{pick}) at high altitude may be a lower than the first threshold pressure (P_{pick}) at lower altitude, such as may be useful for giving the vacuum system more time to establish the seal at high altitudes. In some instances, a user may input the altitude and/or location of the retrieval device, such that the altitude and/or location of the retrieval device may be incorporated into the relationship between the open pressure (Pₒₚₑₙ) and the first threshold pressure (P_{pick}). Further, or instead, the location of the system may be determined by a remote server (e.g., based on an IP address of the system).

As shown in step 508, the exemplary method 500 may include controlling operation of the vacuum pump based on the first threshold pressure (P_{pick}). For example, controlling operation of the vacuum pump may include controlling a supply voltage of the vacuum pump based on the first threshold pressure (P_{pick}). For example, the supply voltage of the vacuum pump may be increased as the first threshold pressure (P_{pick}) increases, with a limit to the increase of the supply voltage corresponding to a rated voltage of the vacuum pump. Additionally, or alternatively, the supply voltage may be decreased as the first threshold pressure (P_{pick}) decreases, with a lower limit to the decrease of the supply voltage corresponding to conditions likely to stall the vacuum pump.

As shown in step 510, the exemplary method 500 may include receiving a second pressure measurement signal (Sₚ₂) indicative of pressure in the nib with the opening in contact with the pill. For example, in instances in which pill pick-up is successful, the vacuum system may continue to draw the pill onto the nib until a good seal is established. As used in this context, a second threshold pressure (Pₛₑₐₗ), corresponding to a good seal between the pill and the opening of the nib represents differential vacuum pressure, below which the pill is likely to remain engaged to the nib as the nib moves out of the container and toward a dispensing area, such as a chute. In certain implementations, the second threshold pressure (Pₛₑₐₗ) may be a constant value (e.g., about −45 kPa) that does not change with system degradation. Additionally, or alternatively, second threshold pressure (Pₛₑₐₗ), may be a constant value that changes based on one or more parameters of an environment about the retrieval device. The one or more parameters may be based on location of the retrieval device (e.g., altitude). Thus, for example, in instances in which the second threshold pressure (Pₛₑₐₗ), is about −50 kPa at sea level, the second threshold pressure may be changed to about −40 kPa at high elevations (e.g., elevations greater than about 8000 ft.). The detection of altitude in this context may be carried out according to any one or more of the various different techniques described above. In certain instances, adjusting the second threshold pressure (Pₛₑₐₗ) may include receiving the location as an input from a user. Further, or instead, adjusting the second threshold pressure (Pₛₑₐₗ), may include receiving the location from a remote server in communication with the retrieval device. For example, the location of the retrieval device may be based on an Internet Protocol (IP) address of the retrieval device in communication with the remote server.

As shown in step 512, the exemplary method 500 may include actuating a positioner to move the nib from a first position above a container to a second position above a chute. In particular, such movement of the positioner may be based on whether the second pressure measurement signal (Sₚ₂) is less than the second threshold pressure (Pₛₑₐₗ) when the nib is at the first position above the container, indicating that there is a good seal between the nib and the pill at that position.

As shown in step 514, the exemplary method 500 may include, as the nib moves from the first position to the second position, comparing the second pressure measurement signal (Sₚ₂) to a second threshold pressure (Pₛₑₐₗ) indicative of pressure below which the opening of the nib is in sealed engagement with a pill. In general, the comparison of the second pressure measurement signal (Sₚ₂) to the second threshold pressure (Pₛₑₐₗ) may form a basis of determining dispensation of the pill in the chute. If the second pressure measurement signal (Sₚ₂) inadvertently rises above the second threshold pressure (Pₛₑₐₗ) while the nib is over the chute, the pill may be deemed dispensed, even if the interruption in the seal above the chute was inadvertent. That is, whether intentional or not, interruption in the seal above the chute may be deemed successful dispensing of the pill to the user, and this information may be recorded or verified as described in greater detail below. Similarly, if the second pressure measurement signal (Sₚ₂) rises above second threshold pressure (Pₛₑₐₗ) when the nib is not above the chute, the dispensing attempt may be recorded as unsuccessful.

As shown in step 515, if the second pressure measurement signal (Sₚ₂) rises above the second threshold pressure (Pₛₑₐₗ) before the nib reaches the chute, the exemplary method 500 may include initiating a remedial action. In general, the remedial action may include any one or more of various different types of remedial actions described herein and, more generally, may include any one or more of various different remedial actions as may be useful for promoting accuracy, safety, and efficiency of operation of the retrieval device. Thus, for example, initiation of the remedial action may include generating an error indicating that the pill has dropped. The error may be sent, for example, to a user interface of the retrieval device and/or communicated over a network. Further, or instead, initiating the remedial action may include making another attempt to retrieve and dispense the pill to the user, such as by repeating any one or more of various different steps of the exemplary method 500. While remedial actions have been described in the context of the second threshold pressure (Pₛₑₐₗ), it shall be appreciated that the remedial action may additionally or alternatively be initiated based on the open pressure (Pₒₚₑₙ), such as when the open pressure (Pₒₚₑₙ) is below a predetermined cut-off and, thus, indicates the presence of a severe blockage.

As shown in step 516, if the second pressure measurement signal (Sₚ₂) remains less than or equal to the second threshold pressure (Pₛₑₐₗ) as the nib moves from the first position above the container to the second position above the chute, the exemplary method 500 may include releasing vacuum pressure at the opening of the nib to drop the pill into the chute. For example, with the nib in position over the chute, the vacuum pump may be turned off and a valve (e.g., a solenoid) may be released to release the vacuum pressure in the vacuum system and drop the pill into the chute. With the vacuum pump off and the valve released, the vacuum system is at ambient pressure and, thus, the pressure reading does not provide a useful indication of whether the pill successfully dropped from the nib.

Accordingly, as shown in step 520 and step 522 of the exemplary method 500, to determine whether the pill has been successfully dropped from the nib, the valve may be closed and the vacuum pump may be re-actuated to re-pressurize the vacuum system following an attempt to dispense the pill.

As shown in step 524, the exemplary method 500 may include receiving a third pressure measurement signal (Sₚ₃) indicative of pressure at the opening of the nib with the vacuum system re-pressurized. The third pressure measurement signal (Sₚ₃) may be received from the same pressure sensor associated with one or both of the first pressure measurement signal (Sₚ₁) or the second pressure measurement signal (Sₚ₂). That is, the pressure measurement signals described herein may be understood to be the same pressure measurement signal received at different times as the exemplary method 500 is carried out.

As shown in step 526, the exemplary method 500 may include comparing the third pressure signal (Sₚ₃) of the re-pressurized vacuum system to the second pressure threshold (Pₛₑₐₗ) to determine whether the pill has actually dropped from the nib and has not, instead, remained stuck to the nib, even after the vacuum pressure has been released. If the third pressure signal (Sₚ₃) is less than the second pressure threshold (Pₛₑₐₗ), this indicates that the pill has not actually dropped from the nib, and any one or more of various different remedial actions described herein may be initiated.

As shown in step 528, if the third pressure signal (Sₚ₃) of the re-pressurized vacuum system is less than the second pressure threshold (Pₛₑₐₗ), the exemplary method 500 may include comparing the third pressure measurement signal (Sₚ₃) to a third threshold pressure (Pₕₑₐₗₜₕ) indicative of blockages in the vacuum system. That is, the third pressure measurement signal (Sₚ₃) of the re-pressurized vacuum system above the third threshold pressure (Pₕₑₐₗₜₕ) may be interpreted to indicate that the vacuum system is free of blockages that are likely to interfere with functionality of the vacuum system and, ultimately, interfere with the overall retrieval and dispensing functions. Under normal operating conditions, the third threshold pressure (Pₕₑₐₗₜₕ) may be close to the open pressure (Pₒₚₑₙ). In some instances, these values may be equal to one another in the absence of a blockage on the nib. However, to account for signal noise from the vacuum pump, the third threshold pressure (Pₕₑₐₗₜₕ) may be a predetermined multiple of the open pressure (Pₒₚₑₙ). As an example, a predetermined ratio of the open pressure (Pₒₚₑₙ) to the third threshold pressure (Pₕₑₐₗₜₕ) may be less than 1. As a more specific example, in instances in which the open pressure (Pₒₚₑₙ) is −3 kPa differential pressure, the ratio of Pₒₚₑₙ/Pₕₑₐₗₜₕ may be greater than about 0.15 and less than about 0.4. It shall be appreciated that the ratio may be adjusted according to any one or more of various different ambient parameters, such as altitude determined according to any one or more of the various different techniques described herein.

In some instances, dynamic adjustment of the third threshold pressure (Pₕₑₐₗₜₕ) based on the open pressure (Pₒₚₑₙ) may be useful for detecting a nib blockage failure mode. Such a failure mode can occur, for example, when there is a small pill or a broken pill is picked from the container and becomes lodged within the nib. In this scenario, the presence of the small pill or the pill fragment within the nib may be detected based on comparison of the third pressure measurement signal (Sₚ₃) to the third threshold pressure (Pₕₑₐₗₜₕ).

Instances in which third pressure measurement signal (Sₚ₃) is greater than the second threshold pressure (Pₛₑₐₗ) and less than the third threshold pressure (Pₕₑₐₗₜₕ) may be indicative of a condition that is not a complete blockage (e.g., a stuck pill) but is nevertheless anomalous, such as a partial blockage within the nib. Because this condition can be detected using the comparison to the third threshold pressure (Pₕₑₐₗₜₕ), the small pill or pill fragment that was retrieved and ultimately became lodged in the nib may be less likely to be erroneously interpreted as a dispensed pill, even though no pill was dispensed (a false pill drop). Thus, if the third pressure measurement signal (Sₚ₃) corresponds to a pressure greater than the second threshold pressure (Pₛₑₐₗ) and less than the third threshold pressure (Pₕₑₐₗₜₕ), a remedial action may be initiated according to any one or more of the various different techniques described herein. For example, initiation of the remedial action may include sending an error signal to a user interface of the retrieval device and/or over a network to indicate an anomalous condition in the vacuum system.

As shown in step 530, if the third pressure measurement signal (Sₚ₃) is greater than the second pressure threshold (Pₛₑₐₗ) and is greater than or equal to the third threshold pressure (Pₕₑₐₗₜₕ), the exemplary method 500 may include recording the pill as successfully dropped or dispensed to the user.

Removal of Material Lodged in the Nib

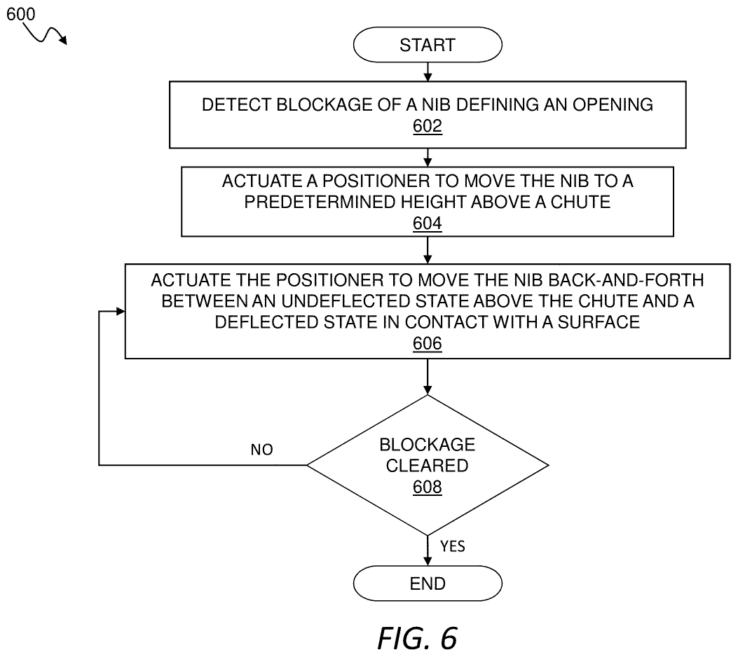

FIG. 6 is a flow chart of an exemplary method 600 of removing debris from a vacuum system of a retrieval device for pills. Unless otherwise specified or made clear from the context, it shall be understood that any one or more of the various different aspects of the exemplary method 600 may be carried out using any one or more of various different aspects of the retrieval device 100 (FIG. 1A), including the controller 116 (FIG. 1A) in electrical communication with the positioner 114 (FIG. 1A), the valve 112 (FIG. 1A), and the vacuum pump 130 (FIG. 1A). For example, the memory 136 (FIG. 1A) may be one or more non-transitory computer-readable storage media having stored thereon instructions for causing the processor 134 (FIG. 1A) to carry out one or more aspects of the exemplary method 600.

As shown in step 602, the exemplary method 600 may include detecting blockage of a nib defining an opening. Unless otherwise specified or made clear from the context, detecting blockage of the nib defining the opening may include any one or more of the various different detection techniques described herein, including the various different techniques for detecting blockage of the nib using pressure in the vacuum system described above with respect to the exemplary method 500.

Thus, for example, detecting blockage of the nib may include actuating a vacuum pump in fluid communication with the opening of the nib, receiving a pressure measurement signal (Sₚ) indicative of a first open pressure (Pₒₚₑₙ) at the opening of the nib with the vacuum pump actuated and the opening of the nib positioned away from material external to the nib. The presence and/or extent of blockage in the nib may be based on the pressure measurement signal (Sₚ).

As shown in step 604, the exemplary method 600 may include actuating a positioner to move the nib to a predetermined height above a chute. At the predetermined height, a flexible portion (e.g., bellows) of the nib may be aligned with a surface disposed between the chute and a support releasably securable to a container.

As shown in step 606, the exemplary method 600 may include, with the nib at the predetermined height, actuating the positioner to move the nib back-and-forth between an undeflected state above the chute and a deflected state in contact with the surface. Importantly, by starting the back-and-forth movement at the predetermined height with the nib positioned over the chute, the opening of the nib may remain directed toward the chute throughout back-and-forth movement of the nib. With the opening of the nib remaining directed toward the chute throughout the back-and-forth movement, debris (e.g., a pill fragment) that becomes dislodged from the back-and-forth movement is likely to be ejected toward the chute, where the debris may be collected and discarded. This is significant because material removed from the nib has the potential to cause damage to one or more components of the system or to contaminate containers of other types of pills.

As shown in step 608, the exemplary method 600 may include determining whether blockage of the nib is cleared. As an example, detecting whether blockage of the nib is cleared may be based on one or more signals indicative of pressure between the nib and an actuated vacuum pump, as described above with respect to the exemplary method 500. In certain implementations, the nib may be moved back-and-forth through a predetermined number (e.g., 5 or 6) of back-and-forth movements until the debris is dislodged (e.g., as determined by iteratively attempting to detect blockage of the nib between each sequence of back-and-forth movements). After each back-and-forth movement of the nib, a pressure measurement signal indicative of pressure in the nib may be checked to see if the blockage has cleared. When the pressure measurement signal is greater than a predetermined threshold pressure (P_{healthy}) indicative of healthy performance of the vacuum system, the blockage may be considered successfully removed and the removal process may be stopped. If the predetermined number of iterations is reached before the blockage is dislodged, an error code may be generated to indicate that the retrieval device has a persistent blockage. The error code may be sent to a user interface to alert the user and/or the error code may be sent to a remote resource via network communication.

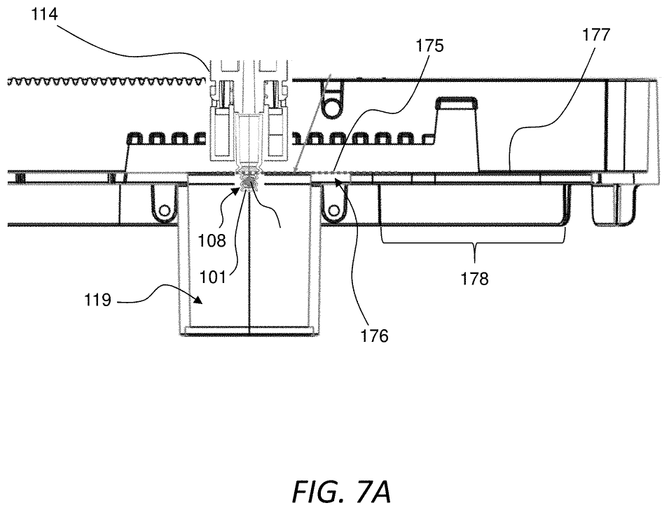

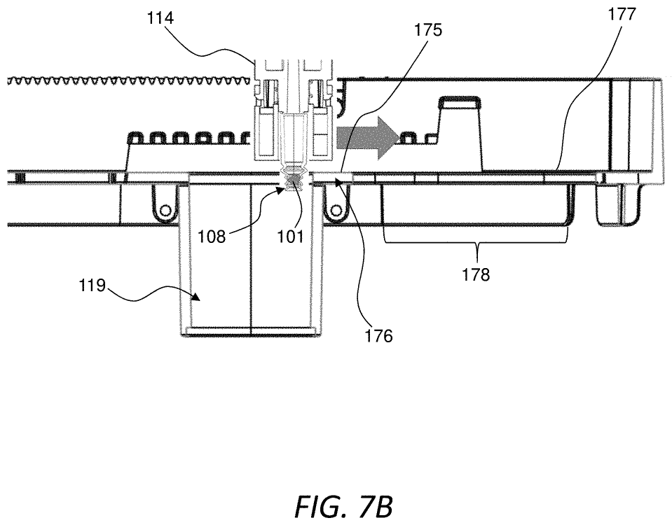

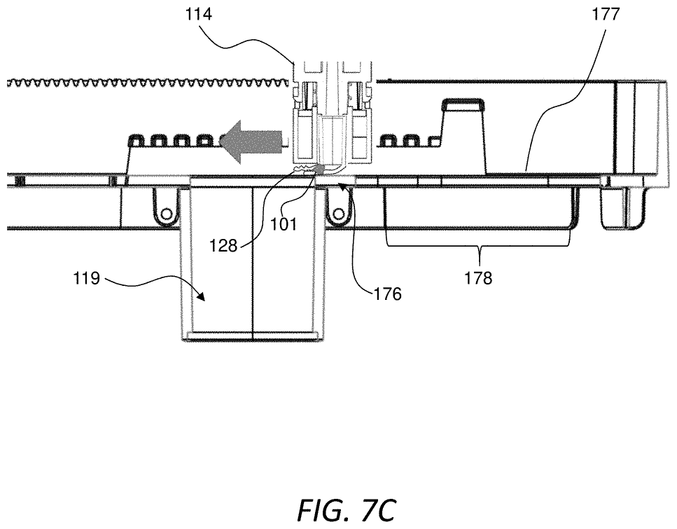

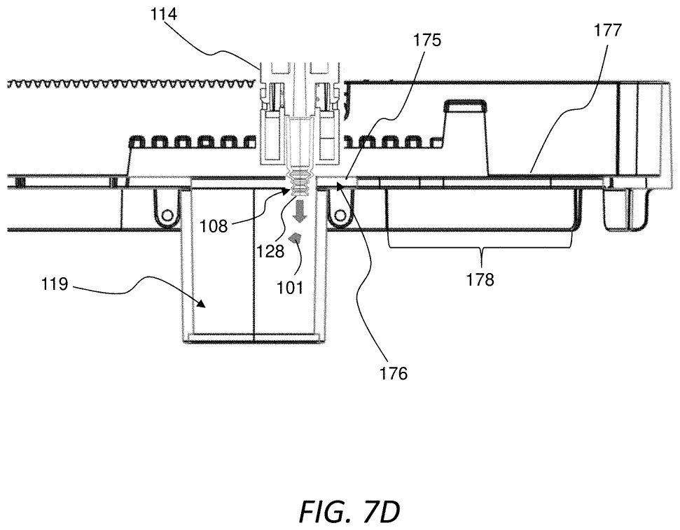

FIGS. 7A-7D, are collectively, a schematic representation of a temporal sequence of operation of the retrieval device 100 to remove material 101 from lodged in the nib 108 according to the exemplary method 600 (FIG. 6).

Referring now to FIG. 6 and FIG. 7A, the nib 108 moved to a predetermined height over the chute 119. For example, the tube 108 may be moved (e.g., lowered) to the predetermined height over the chute 119 such that a flexible portion of the nib 108 (e.g., pleats forming bellows of the nib 108) is aligned with a surface 175 of a plate 176 disposed between the chute 119 and a support 177 releasably securable to a container (e.g., the container 104 in FIG. 1A). For the sake of clarity, the container is not shown in FIGS. 7A-7D. However, unless otherwise specified or made clear from the context, it shall be appreciated that the container 104 (FIG. 1A) may be releasably secured to the support 177.

Referring now to FIG. 6 and FIGS. 7A-7D, with the nib 108 at the predetermined height over the chute 119, the positioner 114 may be moved in a first direction toward the support 177 (FIG. 7B) and then in a second direction (opposite the first direction along an axis) back to the chute 119 (FIG. 7C). This back-and-forth movement results in the nib 108 bending at the pleated portion (where the material 101 is trapped) such that the nib 108 rubs along the surface 175 of the plate 176. Importantly, the degree of motion of the positioner 114 in either direction may be limited to reduce the likelihood of the nib popping out into the cut-out 178 defined by the support 177 and then bending in the opposite direction. That is, by limiting the degree of motion of the positioner 114 in the back and forth direction between the chute 119 and the surface 175, the nib 108 bends only in one direction—namely, the direction in which the opening 128 of the nib 108 points toward the chute 119. Such an orientation of the bending of the nib 108 increases the likelihood that the material 101 lodged inside of the nib 108 will dislodge toward and into chute 119, rather than toward the cut-out 178 defined by the support 177.

In general, the more the positioner 114 is moved to move the nib 108 along the plate 176, the more the nib 108 is subjected to rubbing. Thus, to decrease the potential for damaging the nib 108 through the use of such rubbing to dislodge the material 101, the distance of movement of the positioner 114 may be progressively increased over time if the material 101 remains in the nib 108. Lighter blockages will tend to come undone even with slight jostling of the nib 108, whereas larger blockages may require more jostling.

While differential pressure readings may be useful in determining whether the material 101 has been cleared, it shall be appreciated that other approaches may additionally or alternatively be used. For example, the nib 108 may be moved against a flat surface to determine whether a seal is formed. Sometimes, light blockages may not result in measurable changes in differential pressure but still interfere with the ability of the nib 108 to pick up pills. Thus, running a functional test (e.g., a sealing test) of the nib 108 at the end of a clearing sequence deemed successful via pressure measurements may be useful as an additional check on restoration of functionality of the nib 108.

In certain implementations, the clearing sequence associated with the exemplary method 600 may be activated through a keyed startup sequence. For example, one or more buttons may be held down while the system is plugged in, and the retrieval device may start with this sequence to force start this sequence in an isolated fashion.

Further, or instead, the clearing sequence may be initiated at the end of a dispense cycle in which the block is detected. This may be useful for accurately identifying the material 101 forming the blockage as having provenance in a container from which the previous retrieval was attempted. Thus, continuing with this example, the clearing sequence associated with the exemplary method 600 may be prohibited from running if the blockage is detected after the system is powered on, and before the first retrieval attempt, given that the provenance of such material forming the blockage may be unknown.

Controlling Pump Duty Cycle

Referring now to FIGS. 1A-1C, in certain implementations, the vacuum pump 130 may be the primary source of noise in the retrieval device 100. The controller 116 may turn on the vacuum pump 130 at the beginning of a retrieval and dispensing operation, and the vacuum pump 130 may remain on until the tube 106 is positioned over the chute. With the tube 106 in this position, the controller 116 may turn off the vacuum pump 130 and open the valve 112 in the tube 106 to vent pressure, thus releasing the pill 102. Prior to a pill pick-up, the vacuum pump 130 may be running with the tube 106 (e.g., vacuum line) open. Once the nib 108 forms a seal against a pill 102, the opening 128 in the nib 108 may be closed off by the pill 102, and noise from the vacuum pump 130 may increase in pitch and in volume as the motor of the vacuum pump 130 works against a load to move air.

To reduce noise from the vacuum pump 130, the controller 116 may control the duty cycle of the vacuum pump 130 (e.g., by way of the vacuum control signal Svac). For example, the controller 116 may regulate the duty cycle of the vacuum pump 130, such as by pulse width modulation (PWM). Various duty cycle control methodologies may be incorporated into the one or more vacuum control algorithms stored in the memory 136 as computer-readable instructions for causing the processor 134 to carry out one or more operations described herein.

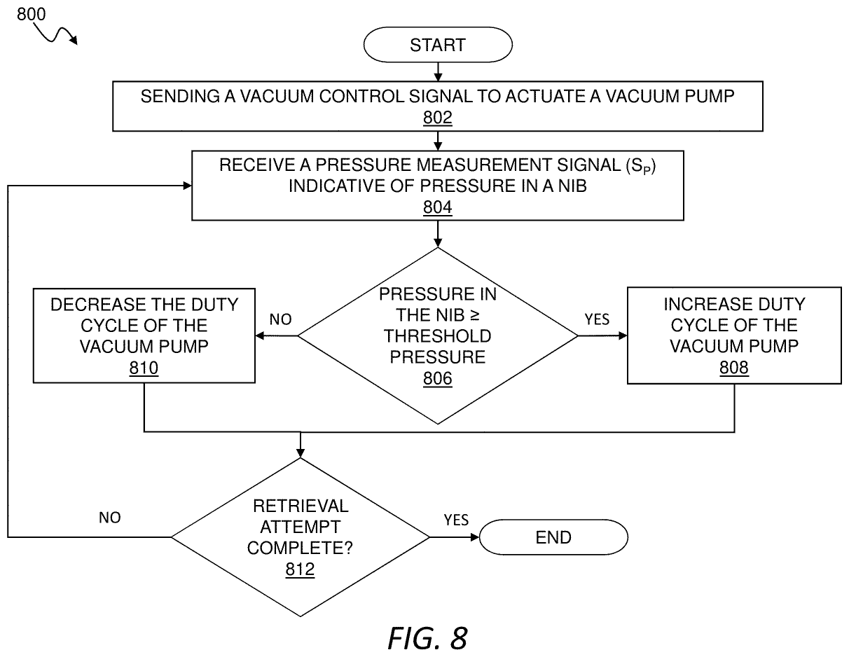

FIG. 8 is a flow chart of an exemplary method 800 of controlling noise of a vacuum system in a retrieval device for pills. Unless otherwise specified or made clear from the context, it shall be understood that any one or more of the various different aspects of the exemplary method 800 may be carried out using any one or more of various different aspects of the retrieval device 100 (FIG. 1A), including the controller 116 (FIG. 1A) in electrical communication with the positioner 114 (FIG. 1A), the valve 112 (FIG. 1A), and the vacuum pump 130 (FIG. 1A). For example, the memory 136 (FIG. 1A) may be one or more non-transitory computer-readable storage media having stored thereon instructions for causing the processor 134 (FIG. 1A) to carry out one or more aspects of the exemplary method 800.

As shown in step 802, the exemplary method 800 may include sending a vacuum sending a vacuum control signal to actuate a vacuum pump at a predetermined duty cycle. For example, sending the vacuum control signal to actuate the vacuum pump at the predetermined duty cycle may include increasing the duty cycle of the vacuum pump as the nib is moved, along a z-axis, into a container for a retrieval attempt. As a more specific example, increasing the duty cycle of the vacuum pump as the nib is moved into the container may include ramping up the duty cycle of the vacuum pump as the nib is lowered into the container. Further or instead, the predetermined duty cycle of the vacuum pump is greater than about 40 percent and less than about 50 percent, which is a range that, among other things, provides a useful tradeoff between adequate suction and noise.

As shown in step 804, the exemplary method 800 may include receiving a pressure measurement signal (Sₚ) indicative of pressure in a nib with the vacuum pump actuated and in fluid communication with an opening defined by the nib. The pressure measurement signal (Sₚ) may be received, for example, from a pressure sensor. Given that the pressure measurement signal (Sₚ) corresponds to a condition in which the pill is sealed to the opening of the nib, the pressure measurement signal (Sₚ) is analogous to the second pressure measurement signal (Sₚ₂) in the exemplary method 500 (FIGS. 5A-5C).

As shown in step 806, the exemplary method 800 may include comparing pressure in the nib to a predetermined threshold pressure. In general, the predetermined threshold pressure may be based on a first pressure (Pₛₑₐₗ) below which the opening of the nib is in sealed engagement with the pill. For example, the predetermined threshold pressure may be equal the first pressure (Pₛₑₐₗ). In other instances, the predetermined threshold pressure may be a predetermined fraction of the first pressure (Pₛₑₐₗ), as is useful for providing a margin of safety useful for reducing inadvertent pill drops as the duty cycle is adjusted. Additionally, or alternatively, the predetermined threshold pressure may be based on a second pressure (P_{pick}) indicative of a pressure below which the opening of the nib is in at least partial sealed engagement with the pill.

As shown in step 808 and step 810, the exemplary method 800 may include, based on comparison of pressure in the nib to the predetermined threshold pressure, adjusting a duty cycle of the vacuum pump relative to the predetermined duty cycle while the opening of the nib is in sealed engagement with a pill. Adjustment of the duty cycle of the vacuum pump may be limited between a predetermined upper bound and a predetermined lower bound, with the lower bound useful for reducing the likelihood of stalling and the upper bound useful for reducing damage to the vacuum pump. As described in greater detail below, the comparison of the pressure in the nib to the predetermined threshold pressure may form the basis for reducing and/or increasing the duty cycle of the vacuum pump according to any one or more of various different techniques useful for mitigating noise associated with the vacuum system while continuing to provide robust suction during retrieval and dispensing of a pill.

In some instances, adjusting the duty cycle of the vacuum pump relative to the predetermined duty cycle may include decreasing the duty cycle of the vacuum pump from the predetermined duty cycle to a reduced duty cycle if pressure in the nib is less than the predetermined threshold pressure. The reduced duty cycle of the vacuum pump may be greater than about 30 percent and less than about 40 percent. In this context, the term “about” shall be understood to include small deviations associated with typical variations in supply voltage to a vacuum pump. While decreasing the duty cycle of the vacuum pump may include reducing the duty cycle of the vacuum pump, it shall be appreciated that decreasing the duty cycle of the vacuum pump may additionally, or alternatively, include turning the vacuum pump off.

In some implementations, one or more of the predetermined duty cycle or the reduced duty cycle may be adjusted, as may be useful for balancing the competing considerations of reducing noise while also reducing the likelihood of inadvertently dropping a pill. For example, one or more of the predetermined cycle or the reduced duty cycle may be adjusted based on historical performance data of the vacuum pump in previous retrieval attempts. The use of such historical performance data may be useful, for example, for adjusting these parameters to reduce noise while accounting for degradation in performance of the vacuum pump or other portions of the vacuum system over time. Further, or instead, the one or more of the predetermined duty cycle or the reduced duty cycle may be based on altitude of the retrieval device, type of the pill, or a combination thereof.

With the vacuum pump operating at the reduced duty cycle, adjusting the duty cycle of the vacuum pump relative to the predetermined duty cycle may include increasing the duty cycle from the reduced duty cycle to the predetermined duty cycle of the vacuum pump if pressure in the nib is greater than or equal to the predetermined threshold pressure.

In certain instances, increasing the duty cycle from the reduced duty cycle to the predetermined duty cycle may include turning the vacuum pump on after the vacuum pump has been shut off. Turning the vacuum pump on after the vacuum pump has been shut off may include, for example, increasing the duty cycle of the vacuum pump to the predetermined duty cycle. Alternatively, turning the vacuum pump on after the vacuum pump has been shut off may include increasing the duty cycle of the vacuum pump to an intermediate duty cycle lower than the predetermined duty cycle.

In some implementations, adjusting the duty cycle of the vacuum pump relative to the predetermined duty cycle may include limiting a number of adjustments of the duty cycle of the vacuum pump to a predetermined number during a given pill retrieval attempt. This may be useful for controlling changes in noise associated with the vacuum pump and, further or instead, may reduce the likelihood of degrading the vacuum pump through excessive cycling of operating conditions.

In some instances, adjusting the duty cycle of the vacuum pump relative to the predetermined duty cycle may include incrementally changing the duty cycle of the vacuum pump over a predetermined period. As an example, incrementally changing the duty cycle of the vacuum pump over the predetermined period may include changing the duty cycle of the vacuum pump according to a ramp function over the predetermined period (e.g., between 2 seconds and 20 seconds). Such gradual change is useful for avoiding sudden changes in noise that can be disruptive in a household environment.

As shown in step 812, the exemplary method may include, throughout at least a retrieval attempt of the pill, repeating the steps of receiving the pressure measurement signal (Sₚ) indicative of pressure in the nib, comparing pressure in the nib to the predetermined threshold pressure, and adjusting the duty cycle of the vacuum pump relative to the predetermined duty cycle. That is, the adjustment of the duty cycle of the vacuum pump may be dynamic to account for changes in conditions that may impact noise and/or suction as a pill is being retrieved.

Referring now to FIGS. 1A-1C, and FIGS. 8-11, having described various aspects of the exemplary method 800, attention is directed now to example duty cycle profiles that may be used in carrying out the exemplary method 800. It shall be appreciated these duty cycle profiles are described in detail below for the sake of explaining various useful aspects of the exemplary method 800 and, unless otherwise specified or made clear from the context, these example duty cycle profiles shall not be considered limiting with respect to the exemplary method 800.

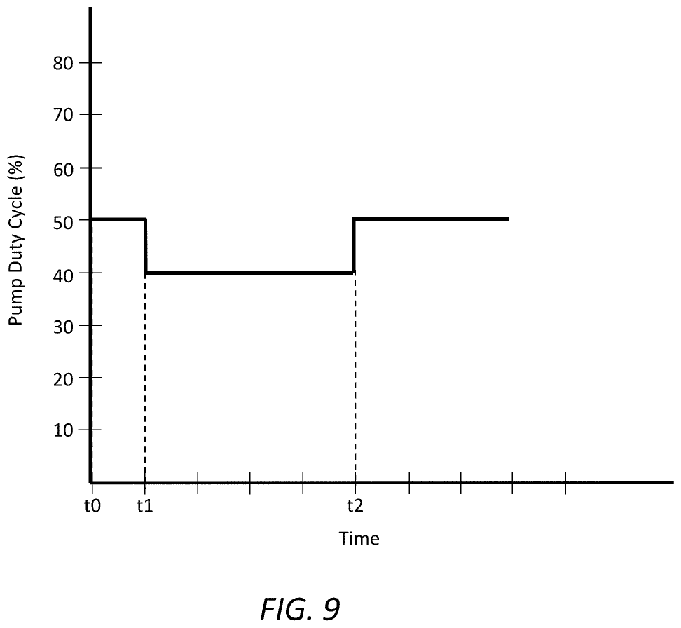

FIG. 9 is a schematic graphical representation of a first duty cycle profile of the vacuum pump 130 of the vacuum system 110 for a retrieval and dispensing operation. At time t0, the controller 116 may control the vacuum pump 130 to run initially at a default duty cycle. For example, the default duty cycle may be about 50% duty cycle. Additionally, or alternatively, at t0, the controller 116 may begin monitoring (e.g., continuously monitoring) the pressure measurement signal Sp.

While noise from the vacuum pump may decrease appreciably when duty cycle is reduced, such reduction in the duty cycle may reduce the rate of air flow. This, in turn, may increase the difficulty of quickly forming a good seal against a pill 102. However, after a good seal is formed, the duty cycle of the vacuum pump 130 only needs to be high enough to ensure the seal is maintained, and reducing the duty cycle by even 5-10% can significantly decrease audible noise from the vacuum pump 130, especially when the vacuum pump 130 is running under load. Note, however, that reducing duty cycle too much below a lower limit (e.g., about 40%) may be undesirable because dropping the supply voltage too far below the rated voltage of the vacuum pump 130 may increase the risk of stalling the vacuum pump 130, especially when the vacuum pump 130 is running under load.

At time t1, the controller 116 may determine (e.g., based on the pressure measurement signal Sp) that the vacuum pressure in the tube 106 is below the “good seal” threshold Pₛₑₐₗ, indicating that a good seal is established between the nib 108 and pill 102. Thus, with a good seal established, the controller 116 may reduce the duty cycle of the vacuum pump 130 from an initial value (e.g., about 50%) to a lower value (e.g., about 40%). As the plunger and carriage are moved over to the chute for pill release, the controller 116 may monitor (e.g., continuously) the pressure measurement signal Sp.

At time t2, the controller 116 may determine (e.g., based on the pressure measurement signal Sp) that the vacuum pressure in the tube 106 is increasing toward Pₛₑₐₗ and/or has increased above Pₛₑₐₗ. Based on such a determination the controller 116 may increase the duty cycle back up to the initial value (about 50% in this example) to reduce the likelihood that the pill 102 will be prematurely dropped by the nib 108 before the nib 108 is positioned above the chute. In certain implementations, the controller 116 may continuously adjust the duty cycle based on the pressure measurement signal Sp (e.g., feedback) from the pressure sensor 133 (e.g., go down to about 40% duty cycle to start, tick back up to about 50% duty cycle if pressure in the tube 106 increases, drop back to 40%, etc.). The controller 116 may limit the number of “bounces” in the duty cycle to control, for example, the disturbance in overall sound.

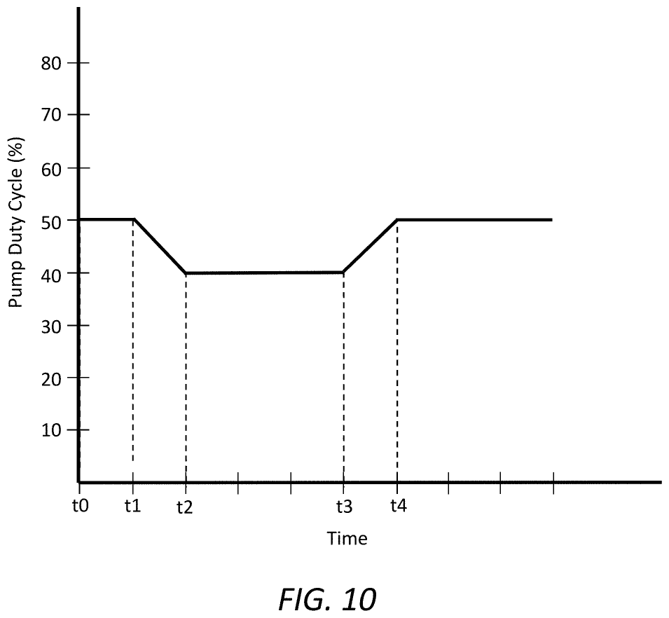

FIG. 10 is a schematic graphical representation of a second duty cycle profile for the vacuum pump 130 for a retrieval and dispensing operation. According to this example, the controller 116 may gradually adjust the duty cycle (e.g., gradually ramping/incrementing) to produce gradual changes in the noise produced by the vacuum system 110. As a specific example, at time t0, the controller 116 may control the vacuum pump 130 to run initially at about 50% duty cycle. At time t1, the controller 116 may determine that the vacuum pressure in the tube 106 is below the “good seal” threshold Pₛₑₐₗ and, based on this determination, the controller 116 may begin to ramp down the duty cycle gradually so that the duty cycle is about 40% at time t2. At time t3, the controller 116 may determine that the vacuum pressure in the tube 106 is above Pₛₑₐₗ and, based on this determination, the controller 116 may begin to ramp up the duty cycle gradually so that the duty cycle is back to about 50% at time t4. While an increment of about 10% has been described, it shall be appreciated that the controller 116 may implement duty cycle ramps by other increments (e.g., 1% increments), with the exact increments based on producing less noticeable jumps/abrupt changes in noise from the vacuum pump 130. In certain implementations, the time between t2 and t3 and between t4 and t5 may be in a range from about 2 seconds to 20 seconds.

In certain implementations, the controller 116 may adjust the pump duty cycle for the retrieval device 100, based on historical performance data (e.g., data stored in the memory 136). This may facilitate adjusting/fine-tuning the duty cycle of the vacuum pump 130 over time, such as may be useful for addressing changing operating conditions associated with environmental conditions, wear, etc. The memory 136 may additionally, or alternatively, store other data such as customer-provided information (e.g., altitude at user location, indication of whether certain pill types (known to be difficult to pick), etc.)) that may be used by the controller 116 to mitigate noise from the vacuum system 110 while maintaining appropriate performance to carry out retrieval and dispensing operation.

In general, at any time (e.g., during the retrieval and dispensing operation), the controller 116 may turn the vacuum pump 130 on or off, or may set the duty cycle of the vacuum pump 130 to be anywhere between an upper bound and a lower bound. The upper bound of the duty cycle may be a value above which components (e.g., pump driver/motor) of the vacuum pump 130 may be at risk of damage and/or failure. Further, or instead, the lower bound of the duty cycle may be a value below which the vacuum pump 130 may be at risk of stalling, especially when running under load (e.g., under sealed condition). The upper bound and the lower bound of the duty cycle may be values stored, for example, in the memory 136. In some instances, the upper bound and the lower bound of the duty cycle may be specifically chosen for the retrieval device 100. The upper bound and the lower bound of the duty cycle may be fixed and/or may be adjustable based on a particular application. For example, one or both of the upper bound and the lower bound may be set at the time of manufacture. Additionally, or alternatively, the upper bound and the lower bound of the duty cycle may be determined by the controller 116, and/or adjustable by the controller 116, based on performance history data, user input, and/or other data stored in the memory 136.

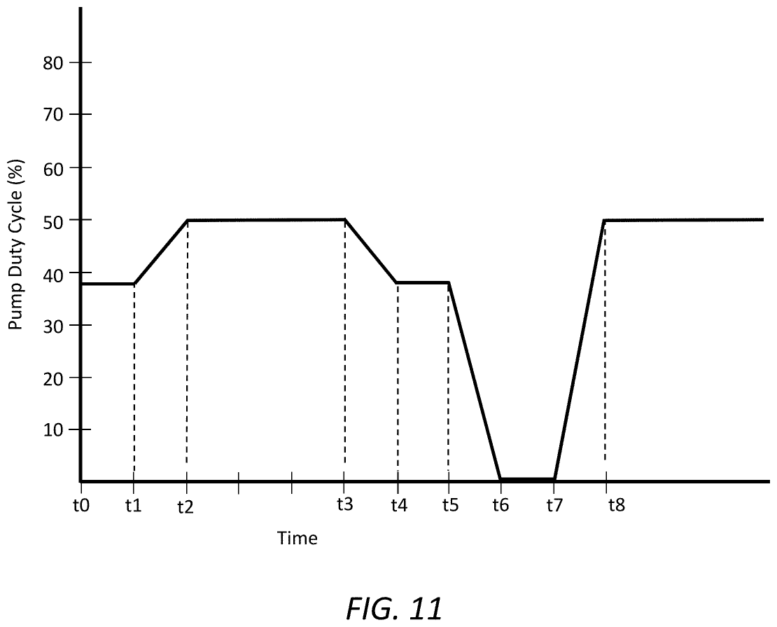

FIG. 11 is a schematic graphical representation of a third duty cycle profile of the vacuum pump 130 of the vacuum system 110 for a retrieval and dispensing operation. In general, the third duty cycle profile may facilitate quickly forming a seal between the nib 108 and the pill 102 while also reducing noise associated with operating the vacuum pump 130 at the lower bound of duty cycle prior to pill pick-up. At time t0, the controller 116 may initially set the pump duty cycle at be the lower bound of duty cycle (e.g., about 38%) stored in the memory 136. The controller 116 may also begin monitoring (e.g., continuously) the pressure measurement signal Sp at time t0.

At time t1, the controller 116 may determine that the positioner 114 has positioned the tube 106 over the container 104, and is beginning to lower the nib 108 into the container 104. Based on this determination, the controller 116 may begin to ramp up the duty cycle of the vacuum pump 130 to a higher duty cycle (e.g., a duty cycle of about 50%) as the nib 108 is plunged into the container 104 for a retrieval attempt. The controller 116 may control the ramping of the duty cycle so that the higher duty cycle (e.g., about 50%) is reached at the time t2, when the nib 108 engages the pill 102. As compared to keeping the duty cycle at the higher duty cycle throughout a retrieval attempt, ramping up the duty cycle may reduce noise from the vacuum pump 130 during a significant portion of time in a retrieval and dispensing operation. While ramping up the duty cycle has been described as being initiated when the nib 108 engages the pill 102, it shall be appreciated that one or more other events may be used to initiate ramping up the duty cycle. For example, the controller 116 may begin ramping up the duty cycle upon determining that a full seal (Pₛₑₐₗ) or partial seal (P_{pick}) is established based on the pressure measurement signal Sp.

At time t3, the controller 116 may determine that a full seal (Pₛₑₐₗ) is established between the nib 108 and the pill 102 based on the pressure measurement signal Sp. At this time, the controller 116 may ramp the duty cycle back down so that the duty cycle at time t4 is at the lower bound, which is shown as 38% in this example.

At time t5, the controller may determine that the seal quality is still above a certain threshold. For example, based on the pressure measurement signal Sp, the controller 116 may determine that the vacuum pressure in the tube 106 is less than Pₛₑₐₗ. Based on this determination at t₅, the controller 116 may turn off the vacuum pump 130 entirely. For example, the controller 116 may ramp down the power to the vacuum pump 130 so that the vacuum pump 130 is off at time t6. Significantly, as compared to keeping the vacuum pump 130 on, turning the vacuum pump 130 off when the seal quality is good may dramatically reduce noise from the vacuum pump 130 while avoiding, or at least reducing, the risk of stalling the vacuum pump 130.

Throughout the retrieval and dispensing operation including after the nib 108 picks up the pill 102, the controller 116 may monitor (e.g., continuously) the vacuum pressure in the tube 106 by monitoring the pressure measurement signal Sp. This may ensure that a strong seal is maintained between the nib 108 and the pill 102.

At time t7, based on the pressure measurement signal Sp, the controller 116 may determine that the vacuum pressure in the tube 106 is above the good seal threshold, Pₛₑₐₗ, indicating that the pill 102 is at risk of becoming prematurely dislodged from the nib 108. Upon detecting this condition, the controller 116 may turn the vacuum pump 130 back on, ramping up duty cycle of the vacuum pump 130 as needed so that, at time t8, the duty cycle of the vacuum pump 130 is up to the upper bound (e.g., 50% in this example) to maintain a good seal. Alternatively, the controller 116 may turn the vacuum pump 130 back on to the lower duty cycle (e.g., 38%). Continuing with this example, if the vacuum pressure then goes back down below Pₛₑₐₗ, the controller 116 may maintain the vacuum pump 130 at the lower duty cycle, as is useful for mitigating noise associated with the vacuum pump 130. However, if the controller 116 determines that the pressure is still above Pₛₑₐₗ after the vacuum pump 130 has been turned back on to the lower duty cycle, the controller 116 may ramp up the duty cycle from lower bound to a higher duty cycle up to and including the upper bound.

By monitoring the pressure measurement signal Sp during the retrieval and dispensing operation, the controller 116 may quickly determine whether the vacuum pressure line (e.g., from the vacuum pump 130 to the opening 128) has a blockage (e.g., pill fragment in the nib 108, filter clog, etc.). The duty cycle of the vacuum pump 130 may affect the steady-state pressure in the tube 106 at the time that the pressure sensor 133 transmits the pressure measurement signal Sp. For example, for the same blockage, the higher the duty cycle, the lower the steady-state pressure reading, and the lower the duty cycle, the higher the steady-state pressure reading. As a result, reducing the PWM of the vacuum pump 130 (e.g., reducing the duty cycle) at the time of these measurements may reduce the ability to distinguish clearly among various blockage states. For example, a very light blockage that may be detectible when running the vacuum pump 130 at a duty cycle of 50% may not be detectible when running the vacuum pump 130 at a duty cycle of 38%. To facilitate retaining as much detection granularity as possible while mitigating noise from the vacuum pump 130, the controller 116 may operate the vacuum pump 130 during a pressure measurement by the pressure sensor 133 at a duty cycle that is higher (e.g., an upper bound of about 50%) than during other portions of the retrieval and dispensing operation. For example, at the beginning of the retrieval and dispensing operation, the controller 116 may initially operate the vacuum pump at a high duty cycle (e.g., about 50%) to measure the steady-state baseline pressure in the tube 106 and make an initial assessment of blockage or other anomalous condition in the tube 106, and then ramp down the duty cycle to a lower duty cycle as described above.

While the foregoing approaches to controlling the vacuum pump 130 have been described as using Pₛₑₐₗ as the threshold for changing the duty cycle and/or turning off the vacuum pump 130, it shall be appreciated that one or more pressure thresholds used for adjusting the duty cycle of the vacuum pump and/or for turning off the vacuum pump 130 may be different from Pₛₑₐₗ in some instances. In particular, one or more thresholds may be based on Pₛₑₐₗ while providing margins that facilitate controlling noise from the vacuum pump 130 while maintaining Pₛₑₐₗ, thus reducing the likelihood of inadvertent pill drops.

As an example, in some instances, P_{pwm_upper_threshold} may be a threshold less than Pₛₑₐₗ (e.g., about 75 percent of Pₛₑₐₗ), and when the pressure measurement signal Sp is indicative of P_{pwm_upper_threshold}, the vacuum pump 130 may be turned back on and/or the duty cycle of the vacuum pump 130 may be increased, as the case may be, according to the control technique being used. Stated differently, because P_{pwm_upper_threshold} is less than Pₛₑₐₗ, using P_{pwm_upper_threshold} as the trigger results in the vacuum pump 130 being turned on and/or the duty cycle of the vacuum pump 130 to be increased while there is still a good seal between the nib 108 and the pill 102, resulting in a more conservative control approach that is less likely to result in inadvertently dropping the pill 102 as the vacuum pump 130 is controlled for noise mitigation.

As another example, in certain instances, P_{pwm_lower_threshold} may be a pressure threshold much less than Pₛₑₐₗ (e.g., about 10 percent of Pₛₑₐₗ). As a specific example, P_{pwm_lower_threshold} may be a value that is close to the maximum vacuum that the vacuum pump 130 is capable of generating given the state of the pressure line (e.g., the presence of a partial filter clog) as well as the operating conditions of the vacuum system 110 (e.g., altitude). When the pressure signal Sp is indicative of P_{pwm_lower_threshold}, the quality of the seal between the nib 108 and the pill 102 is better than Pₛₑₐₗ and the vacuum pump 130 may be turned off and/or the duty cycle of the vacuum pump 130 may be decreased. Thus, the use of P_{pwm_lower_threshold} may facilitate mitigating noise of the vacuum pump 130 while reducing the likelihood of inadvertently dropping the pill 102 from the nib 108 because, at all times, the pressure threshold for determining whether to mitigate noise from the vacuum pump 130 is below the pressure (Pₛₑₐₗ) corresponding to a good seal between the nib 108 and the pill 102.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method of controlling a vacuum system of a retrieval device for pills, the method comprising:
actuating a vacuum pump in fluid communication with a nib defining an opening;
receiving a first pressure measurement signal (Sₚ₁) indicative of an open pressure (Pₒₚₑₙ) of the nib with the vacuum pump actuated and the opening unobstructed by material external to the nib;
based on the first pressure measurement signal (Sₚ₁), adjusting a first threshold pressure (P_{pick}) indicative of a pressure below which the opening of the nib is in at least partial sealed engagement with a pill; and
controlling operation of the vacuum pump based on the first threshold pressure (P_{pick}).

2. The method of claim 1, wherein adjusting the first threshold pressure (P_{pick}) is based on a predetermined relationship between first threshold pressure (P_{pick}) and the open pressure (Pₒₚₑₙ).

3. The method of claim 2, wherein the predetermined relationship includes an empirical relationship between the first threshold pressure (P_{pick}) and the open pressure (Pₒₚₑₙ).

4. The method of claim 2, wherein the predetermined relationship between the first threshold pressure (P_{pick}) and the open pressure (Pₒₚₑₙ) is a function of altitude of the retrieval device.

5. The method of claim 1, wherein adjustment of the first threshold pressure (P_{pick}) includes initiating a remedial action for a vacuum pump in fluid communication with the nib.

6. The method of claim 1, wherein controlling operation of the vacuum pump includes controlling a supply voltage of the vacuum pump.

7. The method of claim 1, further comprising comparing the open pressure (Pₒₚₑₙ) to a predetermined cut-off pressure and initiating a remedial action if the open pressure (Pₒₚₑₙ) is below the predetermined cut-off pressure.

8. The method of claim 7, wherein the remedial action includes aborting an attempt to retrieve the pill, sending an error condition to a server in communication with the retrieval device, or a combination thereof.

9. The method of claim 1, further comprising receiving a second pressure measurement signal (Sₚ₂) indicative of pressure in the nib with the opening in contact with the pill, actuating a positioner to move the nib from a first position above a container to a second position above a chute, as the nib moves from the first position to the second position, comparing the second pressure measurement signal (Sₚ₂) to a second threshold pressure (Pₛₑₐₗ) indicative of pressure below which the opening of the nib is in sealed engagement with a pill, and based on comparison of the second pressure measurement signal (Sₚ₂) to the second threshold pressure (Pₛₑₐₗ), determining dispensation of the pill in the chute.

10. The method of claim 9, further comprising releasing vacuum pressure at the opening of the nib if the second pressure measurement signal (Sₚ₃) remains below the second threshold pressure (Pₛₑₐₗ) from the first position above the container to the second position above the chute, wherein releasing the vacuum pressure at the opening of the nib includes deactivating the vacuum pump and opening a valve in fluid communication with vacuum pump and the opening of the nib.

11. The method of claim 10, further comprising, following release of the vacuum pressure at the opening of the nib, closing the valve, re-actuating the vacuum pump, receiving a third pressure signal (Sₚ₃) indicative of pressure at the opening of the nib with the valve closed and the vacuum pump re-actuated, comparing the third pressure signal (Sₚ₃) to a third threshold pressure (Pₕₑₐₗₜₕ) indicative of blockages in the vacuum system, and determining health of the vacuum system based on the comparison of the third pressure signal (Sₚ₃) to the third threshold pressure (Pₕₑₐₗₜₕ).

12. The method of claim 11, further comprising, if the third pressure signal (Sₚ₃) corresponds to a pressure greater than the second threshold pressure (Pₛₑₐₗ) and less than the third threshold pressure (Pₕₑₐₗₜₕ), sending an error signal to a user interface of the retrieval device to indicate an anomalous condition in the vacuum system.

13. The method of claim 9, further comprising initiating a remedial action if the second pressure measurement signal (Sₚ₂) increases above the second threshold pressure (Pₛₑₐₗ) before the nib reaches the second position above the chute, as the nib moves toward the second position from the first position above the container.

14. The method of claim 9, wherein comparing the second pressure measurement signal (Sₚ₂) to the second threshold pressure (Pₛₑₐₗ) includes adjusting the second threshold pressure (Pₛₑₐₗ) based on one or more parameters of an environment about the retrieval device. comparing the second pressure.

15. The method of claim 14, wherein the one or more parameters of the environment about the retrieval device are determined based on a location of the retrieval device.

16. The method of claim 15, wherein adjusting the second threshold pressure (Pₛₑₐₗ) includes receiving the location from a remote server in communication with the retrieval device.

17. The method of claim 16, wherein the location of the retrieval device is based on an Internet Protocol (IP) address of the retrieval device in communication with the remote server.

18. The method of claim 14, wherein the one or more parameters of the environment about the retrieval device include altitude at a location of the retrieval device.

19. A method of removing debris from a vacuum system of a retrieval device for pills, the method comprising:
detecting blockage of a nib defining an opening;
actuating a positioner to move the nib to a predetermined height above a chute, the predetermined height aligning a flexible portion of the nib with a surface disposed between the chute and a support releasably securable to a container; and
with the nib at the predetermined height, actuating the positioner to move the nib back-and-forth between an undeflected state above the chute and a deflected state in contact with the surface with the opening of the nib directed toward the chute throughout back-and-forth movement of the nib.

20. A method of controlling noise of a vacuum system in a retrieval device for pills, the method comprising:
sending a vacuum control signal to actuate a vacuum pump at a predetermined duty cycle;
receiving a pressure measurement signal (Sₚ) indicative of pressure in a nib with the vacuum pump actuated and in fluid communication with an opening defined by the nib;
comparing pressure in the nib to a predetermined threshold pressure; and
based on comparison of pressure in the nib to the predetermined threshold pressure, adjusting a duty cycle of the vacuum pump relative to the predetermined duty cycle while the opening of the nib is in sealed engagement with a pill.
